(19) United States
(12) Patent Application Publication
(10) Pub. No.: US 2011/0230334 A1
(43) Pub. Date: Sep. 22, 2011

(54) Composition, Production And Use Of Sorbent Particles For Flue Gas Desulfurization

(76) Inventors: David Goldberg, Boulder, CO (US); Anthony Roystob-Browne, Georgetown, KY (US)

(21) Appl. No.: 12/671,842

(22) PCT Filed: Aug. 1, 2008
(86) PCT No.: PCT/US08/09294

§ 371 Date: Feb. 2, 2010

Related U.S. Application Data
(60) Provisional application No. 60/963,293, filed on Aug. 2, 2007.

(51) Int. Cl. B01J 20/00; B01J 20/12; B01J 35/00; B01J 20/30

(52) U.S. Cl. 502/74; 502/84; 502/400; 502/100

(57) ABSTRACT

The present methods and systems relate to the removal of sulfur oxides and/or mercury from flue gases by use of a sorbent. Sorbent can comprise an alkali or alkaline earth metal oxide, a transition metal oxide catalyst, and a clay. The sorbent can additionally comprise a polyanion for binding mercury oxides and salts. Methods are provided to produce individual sorbent particles of small diameter, resulting in larger numbers of particles. The state of agglomeration of sorbent particles is important, and aspects of the production and composition of the sorbent are specified so as to either prevent agglomeration or to break up such agglomeration if it occurs. Methods of sorbent injection are indicated both to increase effectiveness as well as economic returns.

### CROSS REFERENCE TO RELATED PATENT APPLICATIONS

This application is related to and claims priority from Provisional Patent Application No. 60/963,293, filed Aug. 2, 2007, and titled “Composition, Production and Use of Sorbent Particles for Flue Gas Desulfurization”, and from Provisional Patent Application No. 61/010,948, filed Jan. 8, 2008, and titled “Polyanion Mercury Sorbents”, and from Provisional Patent Application No. 61/063,493, filed Feb. 4, 2008, and titled “Nanoparticle Generation for Flue Gas Sorbents”.

### TECHNICAL FIELD

The present invention relates to the composition and use of sorbents for flue gas desulfurization.

### BACKGROUND

The removal of sulfur from the gaseous emissions of coal-fired boilers would be of major benefit to the environment, removing a major source of “acid rain” and other adverse effects of sulfur oxides (SO_{X}) pollution. Furthermore, coal-fired boilers are under intense regulatory supervision, and pollution can entail significant costs, including the cost of pollution credits.

The use of clay-coated lime sorbents introduced into the flue gas stream for this purpose has been described in a number of issued patents (e.g. U.S. Pat. No. 5,520,898, U.S. Pat. No. 5,334,564, U.S. Pat. No. 5,298,473, U.S. Pat. No. 5,234,877, U.S. Pat. No. 5,225,384, U.S. Pat. No. 5,219,536, U.S. Pat. No. 5,160,715, U.S. Pat. No. 5,126,300, and U.S. Pat. No. 5,114,898, to Pinnavaia and others), but has not been put into use, in part because these methods are either too expensive for common use, have insufficient performance, or lack suitable methods for production.

For example, some of the deficiencies in the prior reference includes the inability to produce the sorbent in continuous processes, relying instead on expensive and, depending on scale, impractical batch processes. In addition, the sorbent involves the marriage of lime and clay chemistries, one of which (lime) is averse to water, whereas the other is “water-loving”. This disparate relationship with water requires careful process control for mixing the components. Furthermore, the temperature at which lime is hydrated is very important, and the presence of the clay, with its often high viscosity, can impede the temperature dispersion during production, leading to unreactive lime.

Furthermore, SO₂ reacts poorly with the sorbent, which relies instead on metal oxides to catalyze the conversion to SO₃, which reacts more quickly. The longer the metal catalyst is present in the flue gas, and the higher the temperature at which the metal oxide in introduced, the higher the conversion of SO₂ to SO₃, or conversely, the smaller the amount of catalyst required. The prior reference uses methods of introducing the catalyst which are non-optimal. In addition, the timing with which the catalyst is added to the sorbent during manufacturing in a continuous process can be important, since the metal oxides can cause catastrophic agglomeration of the clay part of the sorbent, especially with larger iron oxide particles (e.g. 2 micron or greater). With smaller iron oxide particles (for example, less than 1 micron), addition of the iron oxide directly to clay slurries can be performed without significant agglomeration issues, allowing more leeway in the order of components.

The addition of the sorbent to the flue gas stream in the boiler is impeded by the tendency of the sorbent to agglomerate or “cake”. This is likely due to the heating of the injector parts near to the boiler heating, which vaporizes the water in the sorbent that is in contact with the injector parts. As this water vapor travels back in the tube, it reacts with hygroscopic sorbent that is at a lower temperature. This plugs the injectors, and prevents their long term use. Methods that prevent the plugging of the injectors would be of value.

It is also a problem with the prior reference that sorbents can interfere with electrostatic precipitators (ESP), which can cause either excessive plume opacity or arcing in the ESP. Methods that ameliorate these deleterious effects on the ESP would be of value.

It should also be noted that mercury is another important pollutant found in utility boilers, and its presence in the environment has important health consequences. Lime-based sorbents have little or no reduction, however, on mercury levels.

The methods and compositions of the present invention are intended to overcome these and other deficiencies, as described in the embodiments below.

### SUMMARY OF INVENTION

It would be preferable to increase the total reduction of sulfur compounds in flue gas by the production of sorbents with higher sorbent capacity.

It would further be preferable to improve the sorbent production process so that the lime in the sorbent retains its sulfur binding capacity.

It would also be preferable to improve the injection of sorbents into boilers, so that dry sorbents can be used in larger boilers.

It would yet also be preferable to convert a higher fraction of sulfur dioxide to sulfur trioxide, resulting in improved reactivity with sorbent.

It would additionally be preferable to provide sorbent formulations and methods of injection that reduce plugging of injectors during sorbent addition.

It would yet further be preferable to provide a sorbent that reduces of both sulfur and mercury containing compounds in flue gas emissions.

To achieve the foregoing and other preferences as broadly described therein, the present invention is directed to a sorbent for the furnace sorbent injection capture of flue gas contaminants comprising a sorbent base with dry mix fraction between 64% and 95%, a sorbent clay with dry mix fraction between 4% and 30%, and transition metal oxide with dry mix fraction 1% and 6%, wherein the sorbent has added water such that the excess moisture is less than a predetermined amount.

The sorbent can additionally comprise a polyanion in a weight fraction between 0.05% and 5%, wherein the polyanion, and the polyanion can comprises polyphosphate, polymetaphosphate, alginate, carboxymethylamylose, carboxymethylcellulose, carboxymethyldextran, carageenan, cellulose sulfate, chrondroitin sulfate, chitosan sulfate, dextran sulfate, gum arabic, guar gum, gellan gum, heparin, hyaluronic acid, pectin, xanthan, polyacrylates, polyamino acids, polymaleinate, polymethacrylate, polystyrene sulfate, polystyrene sulfonate, phosphonomethylated polyethyleneimine, polyvinyl phosphate, polyvinyl phosphonate, polyvinyl sulfate, polyacrylamide methylpropane sulfonate, polylactate, polybutadiene, polymaleinate, polyethylene, polymaleinate, polyethacrylate, polyacrylate, and polyglyceryl methacrylate.

The sorbent base can comprise calcium oxide. Alternatively, the sorbent base can comprise sodium sesquicarbonate. Also, the sorbent base source can be selected from the group consisting of chalk, condensed calcium oxide, pulverized calcium carbonate, and precipitated calcium carbonate. The chalk can be size-reduced prior to use.

The sorbent clay can comprise a smectite.

The transition metal oxide can comprise an iron oxide. The iron oxide particles can have a median particle diameter of less than 2 microns, or less than 500 nanometers.

The sorbent can comprise particles with a median particle diameter less than 5 microns, or less than 2 microns. The excess moisture in the sorbent is preferably less than 2%, and more preferably less than 1%.

The present invention is further directed to a method for the preparation of a sorbent for furnace sorbent injection capture of flue gas contaminants comprising combining in dry form a sorbent base with dry mix fraction between 64% and 95%, a sorbent clay with dry mix fraction between 4% and 30%, and a transition metal oxide with dry mix fraction 1% and 6%, mixing water into the dry form combination in amounts of water so as to yield a final excess moisture of less than 2%, and blending the dry form combination and the mix water until the sorbent is a free-flowing powder.

The method can further comprise incorporating into the sorbent a polyanion in a weight fraction between 0.05 and 5%, wherein the polyanion is selected from the group consisting of polyphosphate, polymetaphosphate, alginate, carboxymethylamylose, carboxymethylcellulose, carboxymethyldextran, carageenan, cellulose sulfate, chrondroitin sulfate, chitosan sulfate, dextran sulfate, gum arabic, guar gum, gellan gum, heparin, hyaluronic acid, pectin, xanthan, polyacrylates, polyamino acids, polymaleinate, polymethacrylate, polystyrene sulfate, polystyrene sulfonate, phosphonomethylated polyethyleneimine, polyvinyl phosphate, polyvinyl phosphonate, polyvinyl sulfate, polyacrylamide methylpropane sulfonate, polylactate, polybutadiene, polymaleinate, polyethylene, polymaleinate, polyethacrylate, polyacrylate, and polyglyceryl methacrylate.

The polyanion can be included into the mix water prior to its mixing into the dry form combination. Alternatively, the polyanion can be sprayed onto the sorbent after the step of mixing.

The sorbent base can comprise calcium oxide. Alternatively, the sorbent base can comprise sodium sesquicarbonate.

The sorbent base can be derived from a source material selected from the group consisting of chalk, condensed calcium oxide, pulverized calcium carbonate, and precipitated calcium carbonate. The source material can be chalk which is size-reduced prior to use.

The sorbent clay can comprise a smectite. The transition metal oxide can comprise an iron oxide.

The iron oxide particles can have a median particle diameter of less than 2 microns, or less than 500 nanometers. The sorbent can comprises particles with a median particle diameter less than 5 microns, or less than 2 microns.

The sorbent excess moisture is preferably less than 1%. The temperature during blending preferably does not exceed 200° F.

A fraction of the sorbent clay can be added to a fraction of the water prior to the mixing of the water with the dry form combination.

The method can further comprise a second mixing with water, wherein the second mixing occurs during the step of blending. The amount of second mixing water can determined by measuring the amount of free moisture in the sorbent.

The method can further comprise pulverizing the sorbent after the blending to reduce the size of the sorbent particles.

The method can further comprise heating the sorbent, wherein the excess moisture of the sorbent is reduced to a predetermined level, which can be less than 1% excess moisture.

The present invention can yet also be directed to a method for the injection of sorbent into a furnace for the capture of flue gas contaminants, comprising storing the sorbent in a storage bin, transporting the sorbent from the storage bin to an eductor on the side of the furnace, wherein the eductor is located at a location with a predetermined furnace temperature, injecting the sorbent under gas pressure into the flue gas, and collecting the sorbent from the flue gas, wherein the sorbent comprises a sorbent base with dry mix fraction between 64% and 95%, a sorbent clay with dry mix fraction between 4% and 30%, and a transition metal oxide with dry mix fraction 1% and 6%.

The oxygen levels in the furnace are preferably greater than 6%. The oxygen levels can be increased by using increased amounts of combustion air or by adding makeup air to the furnace after the point of combustion.

The sorbent can be pulverized between the storing and the injecting. The predetermined temperature can be greater than 1800° F.

The method can further comprise metering the amount of sorbent injected into the boiler as a function of the cost of the sorbent and the cost of pollution credits, which can also comprise measuring the amount of contaminant that is not captured by the sorbent.

The present invention can yet further be directed to a sorbent for the furnace sorbent injection capture of flue gas contaminants comprising a sorbent foundation and a polyanion which is admixed with the sorbent foundation.

The polyanion can be selected from the group consisting of polyphosphate, polymetaphosphate, alginate, carboxymethylamylose, carboxymethylcellulose, carboxymethyldextran, carageenan, cellulose sulfate, chrondroitin sulfate, chitosan sulfate, dextran sulfate, gum arabic, guar gum, gellan gum, heparin, hyaluronic acid, pectin, xanthan, polyacrylates, polyamino acids, polymaleinate, polymethacrylate, polystyrene sulfate, polystyrene sulfonate, phosphonomethylated polyethyleneimine, polyvinyl phosphate, polyvinyl phosphonate, polyvinyl sulfate, polyacrylamide methylpropane sulfonate, polylactate, polybutadiene, polymaleinate, polyethylene, polymaleinate, polyethacrylate, polyacrylate, and polyglyceryl methacrylate.

The sorbent can additionally comprise a halide salt wherein the halide is selected from the group consisting of chloride, bromide and iodide. The sorbent foundation can comprise a transition metal oxide, wherein the transitional metal oxide can comprise an iron oxide.

The sorbent foundation can comprise a sorbent base, which can be selected from the group consisting of calcium oxide and calcium hydroxide. Alternatively, the sorbent foundation can comprises a material selected from the group consisting of activated carbon, vermiculite, zeolites, smectites, and clays. The sorbent can further comprise an oxidizing catalyst. The oxidizing catalyst can comprise a transition metal oxide.

The present invention yet additionally can be directed to a sorbent for the furnace sorbent injection capture of flue gas contaminants comprising a contaminant binding material, an oxidizing catalyst and a coating material, wherein the sorbent comprises free-flowing particles with less than a predetermined diameter.

The contaminant bonding material can comprise a material selected from the group consisting of calcium oxide, calcium hydroxide, magnesium oxide, magnesium hydroxide, and calcium carbonate. The oxidizing catalyst can comprise a transition metal oxide. The coating material can comprise a smectite clay. The predetermined diameter of the sorbent particles can be less than 5 microns.

### BRIEF DESCRIPTION OF THE DRAWINGS

FIG. 1A is a process flow diagram of a preferred embodiment of the process of the present invention in which solid components are mixed together prior to their interaction with water.

FIG. 1B is a process flow diagram of a preferred embodiment of the process of the present invention in which clay is prepared as a slurry prior to its mixing with lime and iron oxide.

FIG. 1C is a process flow diagram of a preferred embodiment of the process of the present invention in which slurried clay is added both before and after the introduction of iron oxide.

FIG. 2A is a schematic diagram of the seasoning chamber, in which there a multiple temperature sensors and multiple inlet ports for water and clay slurry.

FIG. 2B is a block flow diagram of the process control of the seasoning chamber of FIG. 2A.

FIG. 3 is a graph of the cumulative distribution of particles either by number or by mass.

### DESCRIPTION

Introduction

Ca(OH)₂ (hydrated lime) reacts with SO_{X} to a greater extent than either calcium carbonate/limestone (CaCO₃) or calcium oxide (CaO) during furnace injection. This higher performance has at least two causes: (1) the higher chemical reactivity of hydrated lime with SO_{X}, and (2) the high surface area of the hydrated lime that results from the hydration process. While commercially available Ca(OH)₂ appears to be capable of meeting SO₂ capture of 40-50 percent at a Ca/S ratio of over 2:1, a cost-effective method of enhancing sorbent reactivity and utilization is a more desirable and economic objective.

Reactivity of Ca(OH)₂ sorbents can be modified with the addition of clay containing a metal oxide catalyst to the CaO base to increase sulfation. The clay and the catalyst have different functions, as outlined below.

The catalyst converts ambient SO₂ to SO₃, which has significantly faster reaction kinetics for reaction with CaO or Ca(OH)₂, thus increasing the rate of sulfur capture. In addition, the sorbent is generally added at a temperature higher than 1400° F., which is the decomposition temperature of CaSO₃ (the product of SO₂ reaction with lime), so that SO₂ reaction at the higher temperature will not lead to a stable product, except for smaller fractions of the CaSO₃ that are oxidized to CaSO₄. On the other hand, the CaSO₄ reaction product of SO₃ with lime has a decomposition temperature of over 2200° F. and is generally stable at the higher temperature regimes. Thus, the conversion of SO₂ to SO₃ allows lime sulfation to occur at higher temperatures.

The iron oxide also has the properties of being an SO_{X} sorbent, and therefore adds additional capacity to the sorbent.

Furthermore, the chemistry of the reaction of SO₂ and SO₃ with calcium oxide and hydroxide is somewhat complex, and may involve the creation of sulfide and other sulfur oxidation intermediaries. Iron oxide can take part in catalyzing such reaction.

The clay has important effects as a thermal energy barrier between the hot flue gases (1600-2400° F.) and the lime. At these high temperatures, the lime melts, which significantly reduces the surface area available for reaction with the ambient SO_{X}. The clay functioning as a thermal barrier can serve to slow the melting of the lime. Another effect of the clay may include wetting of the clay “sheets”, so as to increase the surface area of the lime subsequent to melting. In addition, intercalation of clay sheets into the pore structure of the lime may, in the severe temperature changes that occur during injection of the sorbent into the furnace, fracture the lime particles, and therefore preserve additional surface area for aid in the diffusion limited reaction of SO_{X} with lime. The water bound in the clay can serve a function in the process, as well, which can be as a repository of water, which slows the dehydration of the CaO. Furthermore, the heat of vaporization of water in the clay “shell” further slows the heating of the lime core of the particle, once again slowing the dehydration of the lime.

The presence of clay can have other effects, such as the reduction of surface energy at the nucleus/solution interface during hydration, with the resulting increase in the exothermal rate and a smaller crystal size. Yet another effect is the introduction of a hydrophobic material to prevent hydrogen bonding between adjacent adsorbed water layers.

Yet another function of the clay is to reduce agglomeration of the sorbent particles by acting as a dessicant. Agglomeration has the drawback of reducing the number of particles of sorbent per volume, which thereby reduces the rate of the reaction of SO_{X} molecules with sorbent.

Some of these advantages of the use of clay have been explored in the prior reference patents (see, for example, the patents to Pinnavaia and others referenced above). However, the specific ratios of lime to clay and catalyst are highly relevant to the proper performance of the sorbents, and differing methods of production can affect both the performance of the material, as well as its economics. In addition, the manner in which the sorbent is injected into the furnace can affect its performance, as well.

### Sorbent Composition

A preferred source of lime is the use of pebble lime fines, or if such are unavailable, crushed pebble lime. The pebble lime is preferably high calcium, with a magnesium content of less than 8%, and more preferably less than 5%, and most preferably less than 3%. Smaller sized lime particles are preferable, with a mesh of 200 or more being preferable, and a mesh of 325 or more most preferable.

The clay to be used in this embodiment is preferably a smectite clay, which is preferably a montmorillonite clay, with preferably an alkali metal cation, although divalent alkaline earth metals are also useable. An example of an acceptable clay is VolClay HPM-20 from American Colloid (Arlington Heights, Ill.). In general, a smaller mesh is preferable, with mesh size finer than 200 mesh being preferable, and a mesh size finer than 325 mesh being more preferable.

There are many sources of transition metal oxide catalyst. The catalyst is preferably iron oxide or chromium oxide, due to the relative good catalysis effectiveness, coupled with their relative lack of expense. The use of iron oxide is particularly preferable due to its generally lower toxicity and low cost. Vanadium pentoxide is generally a more effective catalyst, but its high cost makes it often unsuitable for flue gas desulfurization. In the following discussion, the use of iron oxide should be read to include the use of any metal oxide catalyst that improves the conversion of SO₂ to SO₃.

The use of very low cost metal oxide is economical preferable, and with respect to iron oxides, micaceous iron oxide, red iron oxide, black iron oxide, and yellow iron oxide. Precipitates or derivatives from “pickle-liquor” are particularly convenient sources due to their wide availability, high quality, and low cost. While Fe₂O₃ (hematite) can serve as catalyst, it is generally preferable to use Fe₃O₄ (magnetite) as it is more resistant to high temperatures.

The rate of catalysis is roughly proportional to the surface area of the metal oxide particle, or roughly the square of the diameter of the particles. For the applications of the present invention, the median size of iron oxide particles is preferably less than 2 microns, and more preferably less than 1 micron, and even more preferably less than 500 nanometers. One example of a suitable catalyst is Bayferrox iron oxide pigment from LANXESS Corporation (Pittsburgh, Pa.) or PIROX high purity magnetite from Pirox, LLC (New Brighton, Pa.). A source of Fe₂O₃ is G98 iron oxide particles from AMROX, containing single digit percentage chromium oxide.

The ratio of lime to clay can be generally as high as 30% and as low as 5%. For example, with montmorillonite clay that has been exfoliated to one layer thickness and with a surface area of approximately 700 m²/g, approximately 2.5 lbs of clay would be sufficient to coat one ton of CaO particles with low surface roughness (0.25%). Larger amounts of the clay are required as the surface roughness of the lime increases. Furthermore, with incomplete exfoliation of the clay, the amount of clay required increases in roughly direct proportion to the thickness of the partially exfoliated clay in layers. For example, for 7 layers, the surface area is now 70 m²/g, requiring now approximately 25 lbs of clay per ton of CaO. It should be noted that an assumption of the values above is that the clay is uniformly distributed over the surface of the lime particles, which is an optimal situation, and unlikely to be exactly met in practice.

In practice, the more complete the exfoliation achieved in production of the sorbent (as will be discussed in more detail below), the less clay that is needed. On the other hand, to the extent that larger amounts of water have a beneficial effect on the sorbent, larger amounts of clay to which the water is bound is also preferable. In general, with well exfoliated clay, it is preferable for the amount of clay to be between 3% and 30% of the lime, and more preferable for the clay to be between 4% and 20%, and most preferable for the clay to be between 5% and 10% of the CaO.

The amount of iron oxide depends significantly on the particle size, with smaller particles requiring less iron oxide. With iron oxide of size approximately 2 microns, it is preferable for the iron oxide to be more than 2% weight fraction of the solid materials, and more preferable for the iron oxide to be more than 4% of the solid materials, and most preferable for the iron oxide to be more than 5% of the solid materials.

In the case of smaller iron oxide particles, the preferred weight fractions above can be decreased roughly by the square of the ratio of the surface area of the iron oxide particles to the surface area of the 2 micron iron oxide particles. For example, if the median size of particle is roughly 500 microns, the preferred weight fraction of iron oxide can be reduced by a factor of approximately 16 (i.e. (0.5 micron/2 micron) squared). There are other factors related to the interaction of the iron oxide with the clay and lime, and the amount of iron oxide should be empirically determined in operating conditions.

It is also preferred that the amount of chromium in the iron oxide be minimized for environmental and health reasons. That is, the source for most iron oxide is pickle liquor from the surface treatment of steel. If the steel has significant chromium content (e.g. stainless steel), the resulting iron oxide will have a high chromium content. Since some fraction of the fly ash will escape from the pollution controls on the plant, and as chromium is a human health environmental hazard, is preferable for the iron oxide to contain less than 6% chromium, and more preferable for the iron oxide to contain less than 3% chromium.

It should also be noted that the weight fraction of iron oxide can be adjusted somewhat according to the temperatures at which the iron oxide is in contact with the flue gas stream, as well as the temperature of the gas at that time, as will be discussed below.

The amounts of water in the sorbent will be determined empirically by the properties of the lime and the clay. In general, the amount of water is determined by the water content of the finished product, and will be the largest amount of water that yields a product with proper flow characteristics. In general, if the amount of water is too high, the clay in the sorbent will cause caking such that the sorbent has the consistency of wet clay. We have found that to maintain flow characteristics, the sorbent preferably has a water content of between 0.25 and 2.5%, and more preferably between 1.0 and 2.0%. This will be discussed more in the sections below on production process control.

It should be noted that alternatives to lime as the sulfur oxide reactant are known, including the oxides of alkali and alkaline metals. An alternative of particular note is sodium sesquicarbonate (natrona). The compositions, methods and principles of the present invention operate on this material in similar ways to that of lime, and in particular, the use of clay to prevent agglomeration, sintering and dehydration, as well as the use of iron oxide to promote the formation of sulfur trioxide with improved reactivity for the metal oxide, are of operational utility. The primary difference between the production of natrona and lime sorbents is that the natrona does not require water of hydration, and that being highly soluble in water, the use of water in the exfoliation of clay must be carefully controlled. However, other aspects of their production and use are similar to that for lime-based sorbents, and will be discussed from time to time below.

### Production of Sorbent

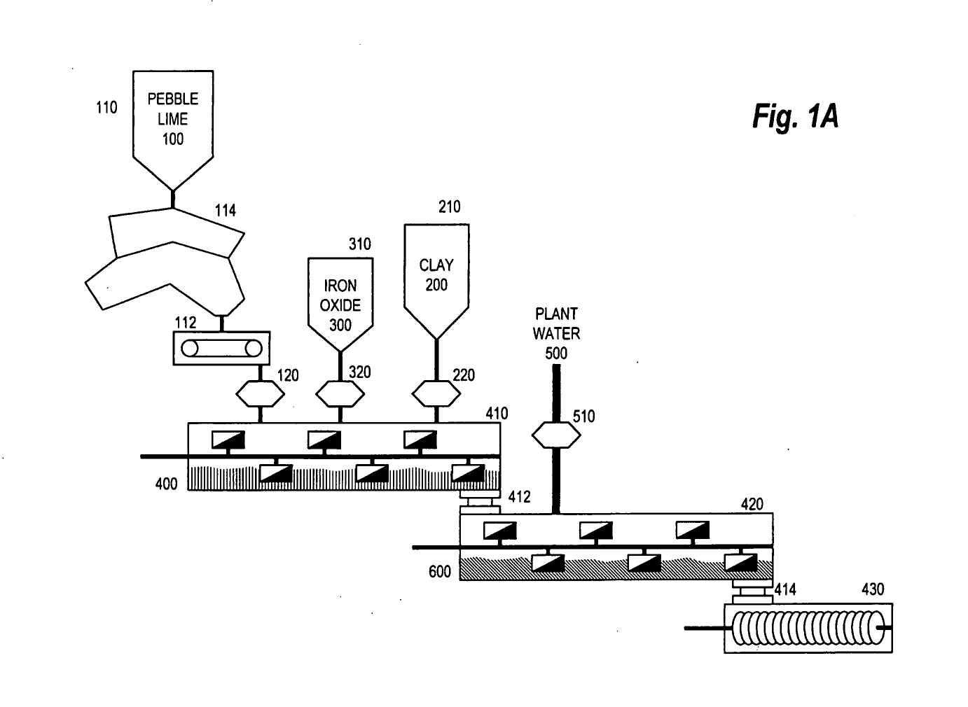

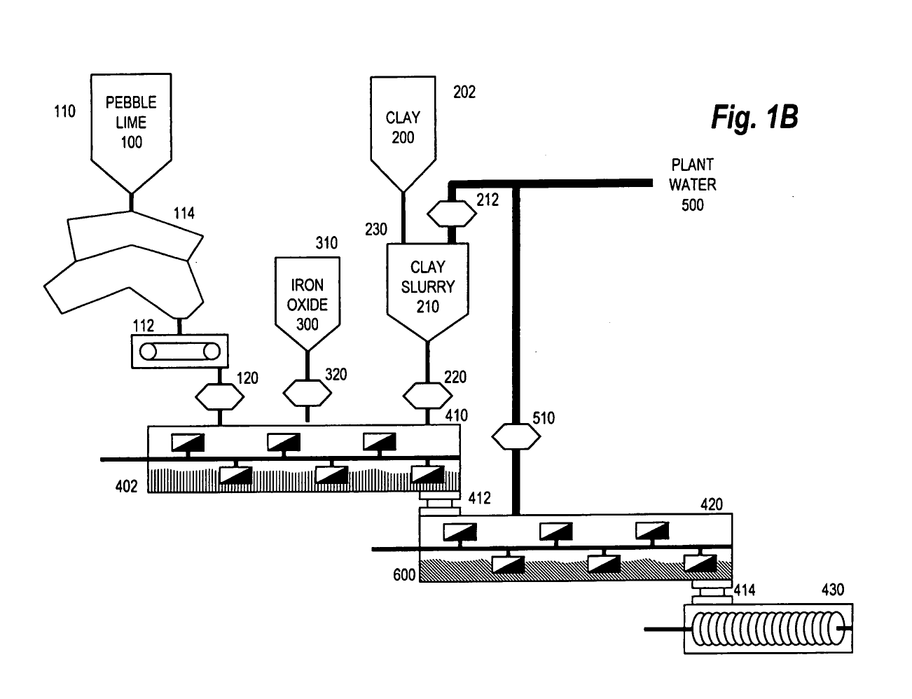

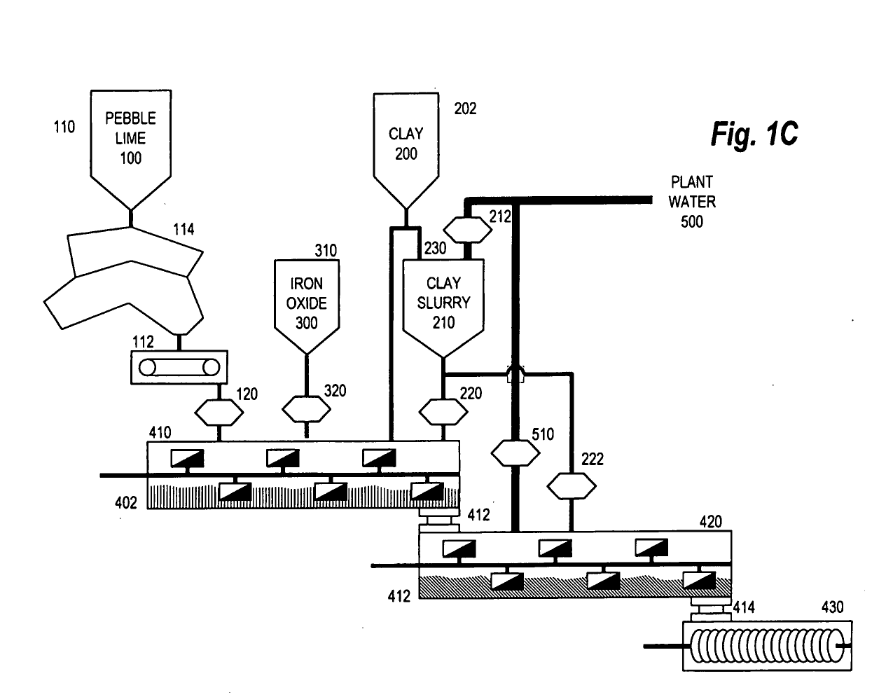

The process for the production of sorbent is illustrated in FIG. 1A, which is a process flow diagram of a preferred embodiment of the process of the present invention in which solid components are mixed together prior to their interaction with water 500.

Pebble lime 100, a described above, is stored in a bin 110, and is fed to a lime screen 114, which separates out larger lime particles. The fines are fed to a weigh feeder 112, and then subsequently to a lime metering device 120.

Clay 200, as described above, is stored in a clay bin 210, from which it is metered by a clay metering device 220.

Iron oxide 300, as described above, is stored in iron oxide bin 310, from which it is metered by an iron oxide metering device 320. It should be noted that other transitional metal oxides are within the teachings of the present invention, and can be used in the following discussion interchangeably with the iron oxide.

The metering devices are used to create within a mixing chamber 410 a dry mix 400 of composition equal to the composition in the final sorbent product. The mixing chamber 410 can be either a batch device, or alternatively, can be used for the continuous production. If for continuous production, the rates of metering lime 100, clay 200 and iron oxide 300 through the metering devices 120, 220 and 320 should be in proportion to their proportions in the final dry mix 400.

In batch mode, the material in the mixing chamber 410 is thoroughly mixed in its entirety. In continuous mode, the material in the mixing chamber is moved through the mixer (e.g. by screws or paddles) towards an “exit point”, but which time the material is completely mixed.

It should be noted that the order of addition of components to the mixing chamber 410 is roughly arbitrary, although in general it is preferable not to mix the clay 200 and the iron oxide 300 directly, as this can cause agglomeration of the clay 200. Furthermore, it is within the teachings of the present invention for two of the components to be mixed in a separate chamber, prior to the final mixing in the mixing chamber 410. In a preferable embodiment, the lime 100 and the iron oxide 300 are mixed together prior to the addition of either clay 200 or clay slurry 210.

The completed dry mix 400 material is transported through a connector 412 to a seasoning chamber 420. It should be noted that the dry mix 400 can be retained in the mixing chamber 410 for a period of time, or even conveyed to a temporary storage bin.

In the seasoning chamber, plant water 500 is added to the dry mix 400, and then mixed using paddles, screws, or other methods. The addition of water 500 is regulated by the water metering device 510. On the completion of this seasoning step, a sorbent 600 will be produced.

In general, mixing in the seasoning chamber 420 will be carried out at relatively high shear, which will break up aggregates as they form, and prevent pockets of high temperature from forming. The control of temperature at this point in the process will be discussed in more detail below.

The placement of the temperature sensor in this case is important, as the temperature of lime during hydration starts at some time period after the introduction of the water, depending on the amount of magnesium in the lime, the size and other physical properties of the lime particles, and the temperature of the water 500. As will be discussed later, the use of multiple temperature sensing devices and multiple water input ports is preferred.

The temperature of the plant water as added to the mix is preferably warmer than 140° F. and more preferably warmer than 160° F. in order to initiate the hydration of the lime 100 component of the dry mix 400. The water can be conveniently heated by placing input lines from the plant water 500 around or next to the seasoning chamber 420, serving as cooling coils for those parts of the chamber 420 that become warmest. Alternatively, if the sorbent production process is part of a larger facility in which lime, for instance, is calcined, the water can be used in the cooling of the pebble quicklime product, simultaneously heating the water. Heating of the input water may not be necessary in a continuous processing mode, where the heat generated by previously added material to the seasoning chamber 140 can serve to initiate the hydration of later added material.

The water 500 is serving two purposes—the hydration of the lime, and the exfoliation of the clay. Sufficient water must be added at all stages of the process in order to carry out these two tasks. In addition, excess water has deleterious effects on the hydrated of lime, and can “drown” the lime, resulting in lime that is coarse and partially hydrated—such lime is unsuited for the current application. Thus, balancing the needs of the lime for limited water and the clay for an excess of water is an important limitation to the process of the current invention, and will be described in more detail later.

In a batch or continuous process, the contents of the seasoning chamber 420 are mixed until the lime has completely hydrated, and sufficient water has been added to completely exfoliate the clay. This amount of water can be difficult to determine, as the amount of water needed to hydrate the lime and the amount of water needed to exfoliate the clay can vary from batch to batch of clay and lime. One method of handling this situation is to continuously add small amounts of water near the end of the process, mixing for a period of time for the water to hydrate lime or clay, and then to measure the overall viscosity of the sorbent 600. The dry sorbent has a very low viscosity, and as water is added to the sorbent, the adhering water binds to the particles and begins to create a slurry, resulting in a rise in viscosity. For certain types of motors driving the mixing paddles or screws, this can be detected as an increase in current usage.

A preferred method of measuring completion of the seasoning is to measure the conductivity of the sorbent between two probes (e.g. using electrical induction measurements). When free water is present in the mixture, there will be appreciable conductivity. As the water 500 is completely utilized by the mixture, free water will disappear, and conductivity will decrease. New water 500 will temporarily increase conductivity, after which its reaction with CaO or binding to clay will result in another decrease in conductivity. The end point for the seasoning process, depending on the precise methods utilized (e.g. batch versus continuous processing, or the number of water 500 or clay 200 feeds, as described below), can be in this case either a specific conductivity reading, or alternatively, a rate of decrease in conductivity. That is, when there is still considerable capacity of unhydrated lime and clay, the decrease in conductivity will be rapid, and as the remaining capacity decreases, the decrease in conductivity will be slower.

In a batch process, the mixture 400 is added to the seasoning chamber 420, water 500 is added at one or multiple times in the process, and the combined components are mixed until completion of the seasoning. At the conclusion of the seasoning, a connector 414 that was previously closed is then opened, and the resulting sorbent 600 is moved (e.g. via screw or through gravity) to a screw mechanism 430 where it is transported to storage or for use in a boiler.

In a continuous process, the mixture 400 is added to the seasoning chamber, and then water 500 is added, and which may be at a number of different locations (see more discussion on this below) or which can be added at the beginning of the seasoning process. The use of multiple locations may be necessary to prevent at any one location the addition of two much water, causing drowning of the lime. The material moves continuously through the process, through, for example, screws or paddles, to the connector 414, which is in a continuous process always open.

Alternative embodiments may be used for this process. For example, FIG. 1B is a process flow diagram of a preferred embodiment of the process of the present invention in which clay 200 is prepared as a slurry 210 prior to its mixing with lime 100 and iron oxide 300.

In one embodiment, the lime 100 and the iron oxide 300 are combined prior to the addition of the clay slurry 210. This prevents agglomeration of the clay 200 in the slurry 210 that can occur with direct addition of iron oxide 300 to slurry 310. Another preferred embodiment is the addition of clay slurry 210 to the lime 100, with subsequent addition of the iron oxide 300.

The clay 200 is mixed with water 500 so that the clay 200 is preferably at a weight fraction of less than 6%. The reason for this cap is that the viscosity of the slurry 210 becomes too large for easy handling above this value. The sources of water and clay in the mixture will be discussed in more detail below.

The clay slurry 210 is comprised of clay 200 and plant water 500, and is combined in high-shear blender 230. The shear activity in the blender 230 should be sufficient to maintain the clay particles in suspension throughout the exfoliation period. It is preferable that the exfoliation period be greater than 2 hours, and more preferable that the exfoliation period be more than 4 hours and most preferable that the exfoliation period be greater than 8 hours.

Once the clay slurry 210 is completely exfoliated in the blender 230, it is added to the lime 200 and iron oxide 300 that is resident in the mixing chamber 410.

It should be noted that it is not always necessary to have both a mixing chamber 410 and a seasoning chamber 420, and that it can be arranged for a single chamber process. For example, in the process of FIG. 1A, the lime 100, clay 200 and iron oxide 300 can be mixed in a seasoning chamber 420, and then subsequently, the water 500 can be added. Similarly, in the process of FIG. 1B, the lime 100, clay slurry 210 and iron oxide 300 can be mixed in the seasoning chamber 420, and the process continue past this point.

In another example, in which there is a continuous processing of sorbent, the mixing chamber 410 can be arranged so that it mixes smaller quantities of lime 100, clay 200 (or clay slurry 210) and iron oxide 300, which are then added continuously to the seasoning chamber 420. In this case, the capacity of the mixing chamber 410 is preferably less than two ton capacity of components, and more preferably less than one ton capacity. As before, addition of iron oxide 300 to the lime 100 is the preferred order of addition of components, although the addition of clay slurry 210 to lime 100 prior to addition of iron oxide 100 can in some concentrations of lime, clay and iron oxide be accommodated.

After the mixing of the lime 100, clay slurry 210 and iron oxide 300 components, the processing with clay slurry 210 proceeds similarly to that of the process of FIG. 1A. One difference will be that less water 500 will be needed to be added to the seasoning chamber 420, as some water will be contributed to the process via the clay slurry 210.

Yet another embodiment of the present invention is presented in FIG. 1C, which is a process flow diagram of a preferred embodiment of the process of the present invention in which slurried clay is added both before and after the introduction of iron oxide. It should be noted that this embodiment is formally similar to the process as would occur where there is not a separate mixing chamber 410 and seasoning chamber, but only a single chamber.

It should be noted that the production of sorbents 600 that are lacking iron oxide 300, as will be discussed later, can proceed similarly to that of the preceding discussion, absent the addition of the iron oxide 300. The combination of the lime 100 and clay 200 or clay slurry 210 has for the most part the same methods and considerations.

The production of sorbents using sodium sequicarbonate natrona uses a somewhat different method of production. Because of the solubility of natrona, differing orders and methods of reaction are used. In a first method, ground natrona is solubilized in water, and this is used to exfoliate and coat clay particles. It is important to reduce, as much as possible, the amount of water that is used. Therefore, saturated or nearly saturated solutions of natrona are preferred. The exfoliated clay/natrona solutions can then be heated in a kiln to reduce the amounts of water, thereby producing a flowable powder.

In an alternate method, a slurry of hydrated/exfoliated clay is mixed with finely ground natrona. This will cause: (1) some of the natrona to solubilize in the free water, and (2) the clay will coat the natrona particles, much in the fashion that happens as described above with respect to hydrated lime. This manner of production is similar to that of coating hydrated lime, as described above, and many of the same considerations apply.

The goal of this procedure is to increase the surface area of the natrona available for reaction. In the boiler, not only does porosity in the natrona develop through calcinations, but in addition, the exfoliated clay provides a very large surface area to which natrona is tightly (through ionic bonds) and loosely bound to the clay. This translates the large surface area of the clay into a large surface area of natrona available for reaction with SO_{X}.

### Materials Budget And Addition of Components

It is instructive to consider that total quantities of lime 100, clay 200 and water 500 that is used in the making of the sorbent 600. Let us consider the case of a sorbent 600 that has X tons of lime 100 and Y tons of clay 200. As mentioned before, Y will generally be between 4% and 35% of X. The amount of water 500 required to hydrate the lime 100 is roughly fixed by the molar stoichiometries of CaO and H₂O in Ca(OH)₂—that is, there is one mole of water 500 per mole of lime 100. Given the different molecular weights of the two components, this means that the ratio of water 500 to lime 100 will be approximately 0.32. However, most lime has components other than CaO, which can include both similar alkaline earth compounds (e.g. MgO), as well as inert compounds. In these cases, the amounts of water 500 necessary to hydrate the lime will vary from this “ideal” ratio, which we will call “RL” (for “ratio lime”).

The amounts of water necessary to hydrate the clay 200 will vary according to the type of clay, the amounts of inert contaminants, and the amounts of water already associated with the raw material, among other factors. Roughly speaking, for the clays 200 of commercial usefulness, the ratio of water 500 to clay 200 will be between 15 and 20 to 1, which we will call “RC” (for “ratio clay”).

However, it is of interest to note that the amounts of water necessary to exfoliate the clay in the presence of lime during the hydration process can be significantly less than that necessary to exfoliate the clay in water alone. The cause for this is due to a number of factors, and include the temperatures generated during lime hydration, the low pH of the hydrated lime solution, and the presence of high density divalent anions on the surface of the lime which serve as counter-ions to the clay (displacing the less tightly bound naturally-occurring monovalent counterions of sodium clays). Indeed, the amounts of additional water that is necessary to exfoliate the clay can be no more than that required to hydrate the lime under normal conditions.

For the purposes of the following calculations and considerations, the amounts of iron oxide 300 can be ignored, as being inert materials with small effects on the amounts of water 500 needed.

The total materials budget (ignoring the iron oxide 300) required for the production of sorbent 600 is therefore:

[1] X lime

[2] Y clay (generally 4-35% of X)

[3] W=(RL)(X)+(RC)(Y) water

The clay 200 can be added either as an unhydrated component (UNCL) or as a slurry 210 (CSL). It should be appreciated that both unhydrated clay 200 and clay slurry 210 can be added as part of the same process. We can then change the materials budget above to reflect this, yielding:

[4] X lime

[4A] UNCL (unhydrated clay)

[4B] CSL (clay slurry)
[4B1] (CSL)(1/(RC+1) clay
[4B2] (CSL)(RC/(RC+1)) water added as slurry

[5] (RL)(X)+RC(UNCL) free water

The clay is accounted for both from the unhydrated clay 200 as well as the clay slurry 210, so that

[6] Y=UNCL+(CSL)(1/(RC+1)

Also, the water is partitioned into two separate additions, so that

[7] W=(CSL)(RC/(RC+1))+(RL)(X)+RC(UNCL)

These two equations ([6] and [7] are both constraints on the process (i.e. that the totals of the water and clay must be consistent with the amounts in the final sorbent 600 product), as well as degree of freedom. That is, we can make the process so that:
1. All of the clay 200 is added as a solid (CSL=0), and all of the water 500 is added as a liquid to dry components.
2. All of the clay 200 is added as a slurry 210 (UNCL=0), and the water 500 is added entirely to the slurry 210.
3. All of the clay 200 is added as a slurry 210, and the water 500 is added partially to the slurry 210, and partially as free water 500 to the seasoning chamber.
4. Some of the clay 200 is added as a slurry 210, and some as dry mix 200, whereas all of the water is added as part of the slurry 210.
5. Some of the clay 200 is added as a slurry 210, and some as dry mix 200, while some of the water is added as part of the slurry 210, and other water is added as free water 500 to the seasoning chamber.

The considerations used in determined which of the clay 200 and water 500 additions to use are grounded in a number of constraints. For example, the clay slurry 210 becomes quite viscous generally above 5-6% clay, which limits the amounts of clay 200 that can be added as part of the slurry 210 (especially in those cases where the ratio of clay 200 to lime 100 is high—above 6-8%). Likewise, this limits the amounts of water 500 than can be added to the slurry 210, past which too much water will be added as part of the slurry 210, and will “drown” the lime 100. If all of the water 500 is added as slurry 210, the slurry can be added continuously throughout the process. The exfoliation of the clay 200 proceeds best when there is an excess of water 500 (and sufficient time), which indicates that creation of the slurry 210 prior to addition to lime 100 has benefits. Also, if all of the water 500 is added as part of the clay slurry 210, it becomes difficult to adjust the amounts and addition times of the water 500 independently of the clay 200. Using these principles, operation in some preferred embodiments are given below.

In one example, all of the components are mixed dry before the addition of water. In this case, there is no slurry. The primary advantage of this embodiment is operational simplicity—there is no need to create a slurry 210 in a separate blender 230. The disadvantage of this embodiment is that exfoliation of the clay is harder with higher ratios of clay to lime.

In a similar example, all of the clay 200 is added as a slurry 210, and additional water is added at various stages of the process as needed. The primary advantage of this embodiment is that the exfoliation of the clay 200 can most easily be controlled, leading to the optimal condition of the clay 200. The primary disadvantage of this embodiment is that the amount of clay that can be added is limited by the amount of water that can be added to the lime 100 balanced by the needs of the clay. For example, using a 5% slurry, reaching a 25% clay content in the final sorbent 600 product could introduce excess water to the combination.

In a related embodiment, clay 200 is added both as a slurry 210, as well as a solid component. Water 500 is also added as both free water 500 and as a component off the slurry 210. This allows the greatest flexibility in the amounts of components, and the times at which components are added. Furthermore, this allows both the independent control of temperature (e.g. to prevent overheating of the lime 100), water for lime 100 hydration (e.g. to prevent “drowning” of the lime), and water to control viscosity (e.g. if the viscosity is too high, it can impair mixing of components and temperature control).

In this example, it is preferable for the clay slurry 210 to be at or above 2% and at or below 6% clay, in order to provide sufficient amounts of clay 200 to encapsulate the lime 100, but not too much that there are handling problems due to viscosity of the slurry 210. It is more preferable for the slurry to be at or above 3% and at or below 5% clay, and it is most preferable for the slurry to be at or above 4% and at or below 5% clay. The remainder of the clay 200 required for the sorbent 600 end-product is mixed dry with the lime 100 prior to the addition of the slurry 210.

Given that the water in the slurry 210 that is added to the clay 200 and lime 100 above will be adsorbed by both the lime 100 and the clay 200, generating heat and increasing viscosity, it is useful to transfer this combination, if not already in the seasoning chamber 420, to the seasoning chamber 420, so that water can be added as needed. The iron oxide can be added prior to the addition of the slurry 210, or alternatively, after the slurry 210 has been well-mixed with the lime 100 and clay 200 combination.

Of the important process control issues, sorbent excess moisture is among the most critical aspects of sorbent effectiveness. With two much moisture, the sorbent agglomerates. When this occurs to a small extent, the adverse consequence is that there are fewer particles, which results in lower particle density in the boiler and slower reaction rates. When this occurs to a larger extent, the sorbent can plug in the transport pipes and the eductors, leading to catastrophic failures. It is most convenient, therefore, that the final sorbent excess moisture be carefully controlled, such that the excess moisture is preferably less than 2%, and more preferably less than 1%, and most preferably less than 0.5%. If the sorbent has higher excess moisture, as will be described below, it can be heated to remove the excess. Other methods of handling high excess moisture will be described below.

### Temperature Control

As mentioned above, it is important to control the temperature of the hydration reactions, which otherwise results in lower reactivity of the resultant hydrated lime (calcium hydroxide). Some part of this oversight comes from the difficulty of working with two different forms of chemistry—clay chemistry and lime chemistry.

It is preferred for the temperature to remain close to, but below, the boiling point of the solution. In general, the slaking of the lime 100 will take place in an open container at normal atmospheric pressure, so that the boiling point will be around 212° F. It should be noted in the following discussion that the boiling point can be adjusted by a variety of factors, both within and outside of factors easily controlled. For example, the boiling point will be lower at elevated altitudes, but can conversely be elevated by addition of ionic or non-ionic solutes, including clay materials in the clay slurry 210. Thus, the preferred values below should be adjusted to the boiling point at the existing conditions (molal boiling point elevation, ambient pressure, etc.).

One aspect of an embodiment teaches the careful control of temperature so as to maintain a temperature during the hydration of the quicklime near to 210° F. homogenously in the mix. Because of local inhomogeneities in the material during hydration (especially given the viscosity at various times in the process), temperature “hot spots” and “cold spots” can occur, with deleterious effect. In order to compensate for these problems, a range of temperatures must be allowed, and the temperature should be maintained preferably above 160° F., and more preferably above 180° F. Similarly, it is highly preferable to maintain temperatures below 210° F.

In order to maintain these temperatures, a number of different approaches can be made in the manner that the water 500 is applied, the manner in which the clay 200 is mixed in with the lime 100, the way that the vessel in which lime 100 is being hydrated is temperature regulated, and the way in which the lime 100 is physically handled during the process.

In previous references, it is most common that the clay 200 and the lime 100 are mixed prior to the addition of water. This has the general disadvantage of needing to control at the same time the hydration of the clay 100 and the hydration of the lime 100. Given that these are natural materials which will have batch-to-batch differences in properties, regulating the rates of hydration of the different materials is made difficult. In general, as mentioned additionally above, it is preferable for at least some of the clay 100 to be separately hydrated from the lime 100, and then subsequently mixed with the lime 100 (and possibly additional clay 200), which is then hydrated in part by the water 500 that is part of the clay slurry 210.

It should be noted, however, that the clay slurry 210 can be quite viscous, and its addition to the lime 100 involves the reaction of the water 500 in the slurry 210 initially with a surplus of lime 100, resulting in a local increase in viscosity. This increase in viscosity inhibits both the mixing of the reagents, as well as prevents the rapid dispersion of high temperatures caused by the exothermic hydration of the lime 100, thus causing problems in temperature regulation. It is therefore preferable, early in the process, for the viscosity of the added clay slurry 210 to be minimized, either through the use of free water 500 in the absence of clay, or alternatively, through the use of clay slurries 210 with lower amounts of clay 200 (e.g. slurries of 4% or less clay). If effects related to high viscosity are encountered, lowering the percentage of clay 200 in the clay slurry 210 (if present), is a useful response.

### General Process Control

Careful process control is important to produce active and commercially priced sorbent 600. The process control is based is predicated on the availability of measurements of importance to the process, including temperature, viscosity/free water, and amounts of components. These will be discussed below.

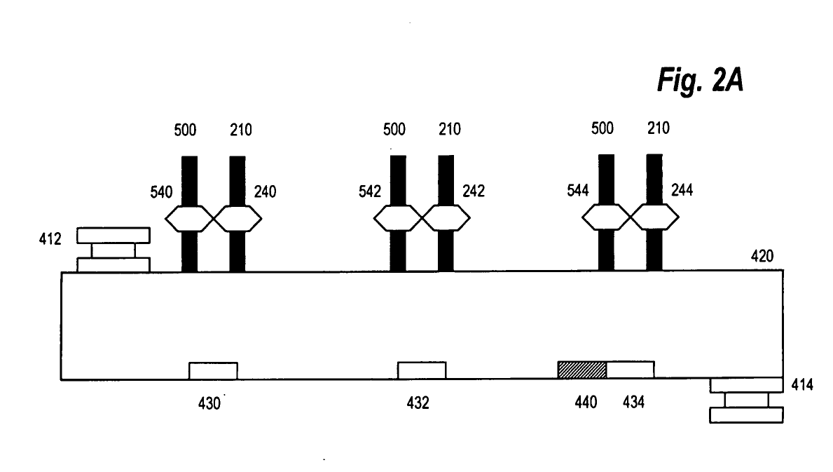

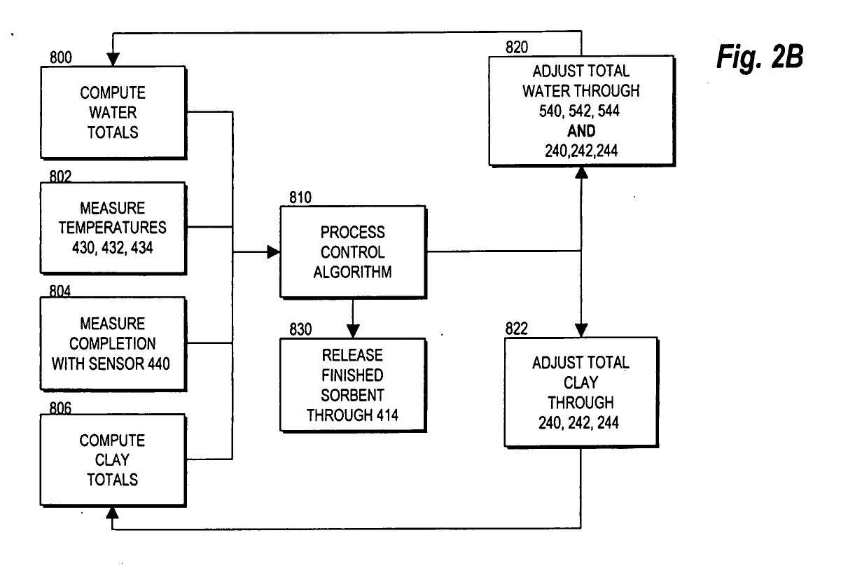

FIG. 2A is a schematic diagram of the seasoning chamber 420, in which there a multiple temperature sensors and multiple inlet ports for water and clay slurry. In this figure, the water metering devices 540, 542, and 544 regulate the addition of water 500 to the seasoning chamber 420. The slurry metering devices 240, 242, and 244 regulate the addition of clay slurry 210 to the seasoning chamber 420. Mixed components from the mixing chamber are passed into the seasoning chamber from connector 412, and finished sorbent 600 exits the seasoning chamber via connector 414.

It should be noted that the process control described below is most application to continuous processing, wherein sorbent 600 is at various states of completion at different locations within the chamber 420. In a batch process, wherein all partially compete sorbent 600 is at roughly the same state of completion, the use of multiple metering devices, and multiple sensors (as described below), is not as critical, and they may be replaced by single devices where there were multiple devices.

There are two types of sensors that can be used in the chamber 420. Temperature sensors 430, 432 and 434 are located preferably at multiple locations. A completion sensor 440 is generally located near the exit connector 414, though multiple completion sensors 440 can be placed at various locations in the chamber 420. As mentioned above, these completion sensors 420 can test conductivity conferred by free water on the surface of the sorbent 600 particles. Alternative methods include tests for viscosity or density.

This information can be used for process control as depicted in FIG. 2B, which is a block flow diagram of the process control of the seasoning chamber of FIG. 2A. Measurements at a time in the process are measured in the steps of the left-hand column. Total water added to the system (both in the mixing chamber 410 and the seasoning chamber 420) are computed in a step 800. Total clay added to the system, whether by dry clay 200 solids in the mixing chamber 410 or through clay slurry 210 in either the mixing chamber 410 or the seasoning chamber 420 are computed in a step 806. The completion sensor 440 measures in a step 804 either some direct measurement related to completion, or an indirect measure that can assist in the determination of completion. Temperatures are measured preferably at multiple locations with sensors 430, 432, and 434 in a step 802.

These measurements are conveyed to a process control algorithm 810, which also considers other information, including the timing, knowledge of the properties of the specific batches of lime 100 and clay 200, goals for the weight fraction of clay 200, and other information to determine the amounts of clay slurry 210 and water 500 yet to be added via the metering devices 540, 542, and 544, and metering devices 240, 242, and 244. If the temperature is climbing and reaches near to the peak of the acceptable range (generally, less than 210° F., and often with a threshold set to above 200° F.), water 500 or clay slurry 210 from a source close to the location of the temperature measurement was obtained. If the mixture has already met the desired weight fraction of clay 200, then water 500 is used to cool the incomplete sorbent 600 mixture. If the mixture has less clay than the desired weight fraction, then clay slurry 210 is instead added. This independent control of clay 200 and water 500 can be very important as the hydration properties of the lime 100 and the clay 200 vary from batch to batch.

On the basis of this information, clay and water metering devices 540, 542, 544, 240, 242, and 244 are used to add clay 200 and water 500 to the seasoning chamber 420 in steps 820 and 822. When the completion sensor 440 has determined that the process is complete, the completed sorbent 600 is released through the exit connector 414 to the screw 430 or other method of transfer to storage or the boiler.

### Practical Production Guidelines

As a general point, the sorbent 600 can be produced at a central location, and then subsequently transported to a variety of utility or other locations at which point the sorbent 600 can be used for flue gas desulfurization. This has the disadvantage that the sorbent has a high volume (and low density), and transportation costs can be high. Alternatively, the sorbent production can take place at or near to the boiler. In this case, either limestone is delivered directly to the utility, where it is then converted into lime 100 and then hydrated to form the sorbent 600, or alternatively lime 100 is made in a central facility, and then transported to remote locations for production and use of sorbent 600. In the discussion below, we will treat the case where lime 100 is produced in a central location, and transported to remote facilities for production and use of sorbent 600, though the overall techniques are scalable, process by process, to much larger, central facilities.

The lime 100 can be delivered by-100 ton covered railcars. The railcar unloading area can be covered by a weather enclosure equipped with a fabric filter system to reduce dust emissions during unloading. Two cars can be unloaded simultaneously.

The railcars can dump the lime 100 into below-grade hoppers which feed a positive pressure pneumatic conveying system. The lime 100 can be stored in two bulk storage silos designed to handle preferably between 15 and 60 days storage of raw materials at full boiler load. The bulk storage silos are preferably equipped with fabric filters capable of handling the full volume of transport air from the pneumatic conveying process.

For feed preparation and storage, the lime 100 can transferred from the bulk storage silos to day bins (preferably from 12 to 30-hour total storage capacity). From the day bins, the lime 100 can be fed to one of two 100% capacity lime atmospheric hydration systems. Each hydration system can comprise a constant weigh feeder, high speed mixing chamber 410, seasoning chamber, vent hood and the necessary control (instrumentation). Lime 100 from the day bin preferably flow by gravity to the weigh feeder. The weigh feeder controls the lime 100 feed rate to the high-speed mixing chamber 410, where the lime 100, the clay 200, and the iron oxide 300 can be mixed with water in the required stoichiometric amount to achieve complete hydration, as described above.

As mentioned above, the clay 200 can be added to the lime 100 both as a slurry 210, as well as solid 200 that is added to the lime 100 prior to hydration. The paste or slurry 402 of lime 100, clay 200, iron oxide 300 and water 500 enters the seasoning chamber 420 where it is retained for the proper length of time to complete the hydration reaction. The seasoning chamber 420 can comprise a horizontal cylindrical vessel with a slowly revolving shaft and paddles to mix the mass of hydrate and advance it slowly towards the discharge end. The completed sorbent 600 preferably overflows from the seasoning chamber 420 into the discharge point as a finely divided powder containing about 0.5% free water.

The sorbent 600 discharged from the seasoning chamber 420 can be pneumatically conveyed to a hydrate storage silo. The hydrate storage silo preferably has a 3-day hydrate storage capacity.

### Post-Production Processing

The sorbent produces by the means above performs efficiently in flue gas desulfurization. There are steps, however, that can be carried out post-production so as to improve the processing.

As mentioned above, agglomeration of particles reduces the efficiency of the sorbent by reducing the number of particles in the boiler. One of the primary issues with agglomeration is the amount of moisture in the final product. It can be hard to provide the exactly optimal amount of water in the hydration reaction, and if too much water is added, it is preferably removed. The removal can best be carried out by heating the mixture so as to evaporate additional water. So as to break up aggregates already formed, this heating should be carried out with vigorous mixing, preferably involving significant shear within the mixture.

When viewed by electron microscopy, lime hydrates have large pores and cracks, making them highly friable (in a microscopic sense). That is, grinding a calcium carbonate particle below 1-2 microns requires significantly more energy than grinding a similar calcium hydrate particle. Grinding the hydrate sorbent (hydrate, and preferably iron oxide and/or clay) releases small particles and can reduce aggregates that might be produced during processing. There will generally be generally at best minor increased surface area during this processing, but the mean particle size will be reduced.

Grinding or pulverization, however, can also reduce internal porosity by collapsing pores under pressure. For this reason, the grinding or pulverization should be performed such that the surface area and/or the pore volume is not decreased by more than 20%, and more preferable that the surface area and/or the pore volume is not decreased by more than 10%, and most preferable that the surface area and/or the pore volume is not decreased at all during the processing. As will be mentioned below, this processing can be performed just prior to injection into the boiler, so as to reduce the agglomeration and increase the number of particles.

### Use of Sorbent

### Principles of Operation

The use of sorbents in the system are governed by the following basic and approximate principles:

1. The reaction of SO₂ with lime is significantly slower than that of the reaction of SO₃ with lime.

2. SO₃ reacts more strongly with Ca(OH)₂ than with CaO.

3. The CaSO₃ (the product of the reaction of CaO with SO₂) decomposes rapidly above 1300-1400° F.

4. At high temperatures (e.g. >2400° F.), the SO₂/SO₃ equilibrium favors the SO₂, while at lower temperatures (e.g. 700-1200° F.), the equilibrium favors SO₃.

5. As SO₃ binds to CaO and Ca(OH)₂ in the flue gas, it drives the reaction towards more production of SO₃ by the law of mass action.

6. At temperatures below 2000° F., the rate of oxidation of SO₂ to SO₃ is relatively small in the absence of catalyst.

7. Iron oxide and other metal oxides can significantly increase the rate of conversion of SO₂ to SO₃ at lower temperatures (e.g. in the range of 700-1200° F.).

8. The temperature in the flue gas decreases very rapidly, from more than 2500° F. to 450° F. in a matter of approximately 2-6 seconds.

These basic principles give rise to the following operational and approximate principles.

1. At temperatures above 1800° F. (depending somewhat on conditions, such as oxygen partial pressure), any SO₃ that is formed must be rapidly removed by sorbent to have an appreciable effect, given that the equilibrium favors SO₂ at this temperature (i.e. there will not be significant oxidation in the absence of sorbent). Removal of generated SO₃ will, by the law of mass action, drive the generation of more SO₃.

2. Catalyst is required for SO₂ oxidation at temperatures below approximately 2000° F.

3. The sorbent is more effective at lower temperatures, as the lime will remain in the hydrated state for longer periods of time, and at high temperatures, the lime liquefies, greatly reducing surface area.

4. The most important limiting steps in sorbent utilization appears to be (a) the conversion of SO₂ to SO₃ and (2) maintaining surface area of the lime.

It should be noted that some of the principles above are in opposition to one another, such that compromises must be made in the operation of the system. These compromises are the basis for the different embodiments of the use of sorbent as described below.

Finally, we will use the term “boiler” in this case to include both the upper furnace as well as convective areas of the boiler. The operative issues in the injection are primarily concerned with the temperature of the flue gas near to point of injection, rather than the specific demarcations along various parts of the flue gas flow.

It should be noted that the injection of sorbent into a boiler (furnace sorbent injection) is well known in the art. Such art includes methods to ensure the rapid and complete dispersion of sorbent. Of particular note are methods described in U.S. Pat. No. 5,809,910 issued Sep 22, 1998 to Svendssen, US Patent Application 20070009413 to Higgins and Schilling. In the sections below, we include the use of such techniques, with differing sorbent mixtures injected at differing locations in the boiler (e.g. at different temperatures). It should be noted that there is no universally-applicable injection location, as the location can vary with a variety of parameters, including the topology of the boiler, the types and compositions of the sorbents, the types and conditions in which the coal is combusted.

### Application of Catalyst-Containing Sorbent

One embodiment of the present invention involves the application of the sorbent 600 containing lime 100, clay 200 and iron oxide 300 catalyst prepared as above. This has a number of operational advantages, in terms of having only a single point of injection. Furthermore, because the iron oxide 300 is bound with the lime 100, any SO₃ oxidation product will quickly react with the adjacent lime 100. If the lime 100 and the iron oxide 300 are added separately, for example, there would be no guarantee that the dispersion of the reaction within the flue gas would be even for both reagents.

An important issue is the temperature at which the sorbent 600 is injected into the flue gas. In practice, it is preferred that the temperature be between 1000° F. and 2400° F., and more preferable that the temperature be between 1400° F. and 2400° F. and most preferable that the temperature be between 1800° F. and 2400° F. The higher temperatures (e.g. >1800° F.) increase the rate of SO₂ oxidation, wherein the close juxtaposition of the lime 100 captures the newly created SO₃ and therefore keeps the equilibrium moving toward the oxidized product via the law of mass action. At the same time, the higher temperatures increase the dehydration of lime 100 in the sorbent 600, which decreases the reactivity of the sorbent 600. Lower temperatures provide slower conversion of SO₂ to SO₃, though a more favorable equilibrium mix of SO₃, and better hydration of lime 100 in the sorbent 600.

The iron oxide 300 or similar catalyst can be added separately from the lime 100 and clay 200. As mentioned above, the sorbent 600 does not necessarily include the iron oxide 300, forming a lime 100 and clay 200 sorbent.

Another preferred embodiment is to add the iron oxide at a higher temperature than that of the lime 100 and clay 200. This allows the independent control of the two processes (SO₂ oxidation and SO₃ capture). In all cases of this embodiment, it is preferable for the iron oxide to be injected into the flue gas stream at a temperature higher than that of the temperature at which the lime-clay sorbent 600 is added.

The temperature for separate iron oxide 300 injection is very broad. If the injection temperature is very high (e.g. >2400° F.), until the temperature drops, very little SO₃ will be generated (due to the unfavorable equilibrium at those temperatures). However, as the temperature decreases, the iron oxide 300 will have sufficient time to become well distributed in the flue gas flow, and the reaction will have more time to reach equilibrium. In general, it is preferable to inject the iron oxide 300 above 1800° F., and more preferable to inject the iron oxide at more than 2000° F. Indeed, the iron can be added in conjunction with the coal, which will ensure broad distribution of the iron oxide.

With the subsequent addition of sorbent 600, any ambient SO₃ will quickly react with the lime 100, which through the law of mass action will permit the continued production of SO₃. If the sorbent 600 is added at too low a temperature, as the SO₃ reacts with the lime 100, the oxidation of SO₂ may proceed too slowly, even in the presence of iron oxide 300 catalyst, to effectively remove SO₂ from the flue gas. Furthermore, at the lower temperatures, the duration of the sorbent in the boiler is necessarily lowered, as the temperature is a roughly monotonic function of distance along the boiler.

### Practical Injection Guidelines

Sorbent 600 can preferably be pneumatically conveyed from the hydrate silo to the furnace sorbent injection location using positive pressure blowers. The flue gas temperature at the injection point is preferably as described above. The injection pipes preferably extend only far enough into the boiler to avoid backflow of the sorbent and abrasion to adjacent wall tubes. The solids are blown directly into the boiler at high enough pressure to achieve distribution of the super sorbent across the width of the furnace, according to the furnace sorbent injection methods as described above.

The flue gas passes through the furnace cavity, boiler convection pass, economizer and air heater, carrying the entrained spent sorbent 600 and fly ash particles into the ductwork beyond the air heater, in order to lower the gas volume for improved particulate removal and to increase the SO₂ removal by activating the unused CaO to allow reaction with additional SO₂ or SO₃ in the flue gas stream. Note that with the addition of iron oxide 300, the conversion from SO₂ to SO₃ can continue even at lower temperatures.

The flue gas can be humidified and cooled to 177° F. by injecting water and air through an array of dual-fluid atomizers in the ductwork. Compressed air at 65 psig is used to shatter the water droplets exiting the atomizers in order to produce smaller droplets (30 micron mean diameter) which will evaporate within a one second residence time in the ductwork. The air is preferably compressed by one of two centrifugal air compressors (one operating and one spare). The humidification of the air has the advantage of improving the performance of the sorbent 600, and improving the performance of electrostatic precipitators ESP for the removal of sorbent 600 and fly ash, but has attendant problems related to the generation of sulfuric and sulfurous acids (through the reaction of SO₃ and SO₂ with water) which can be corrosive, as well as causing some agglomeration of sorbent 600 and fly ash.

Insulation can be been added to the particulate control device (ESP) to prevent the temperature of the gas in the ESP from dropping below the design approach to adiabatic saturation temperature.

The spent sorbent/fly ash mixture can be captured in an ESP. A positive pressure pneumatic conveying system can be used to transfer the solids from the hoppers to the storage silos. These silos are preferably sized for three days storage and are equipped with aeration air blowers to fluidize the bottom of the silos when loading the solid waste into trucks.

A new silo can be used to handle the incremental solids capacity. The solids are mixed with water in two 67% capacity pugmills for dust control (to 20% moisture) and loaded into off-highway dump trucks. The product is then hauled to a landfill site where it is spread and compacted to an average depth of 30 feet. Alternatively, the product can be used for fill in road construction, as an additive for fertilizer, and for other purposes.

The agglomeration of sorbent particles is of interest to the application of the sorbent. Furthermore, as mentioned above, the hydrate in the sorbent is friable, and the production of additional particles is of practical importance to the efficiency of the sorbent. For that reason, higher efficiency will obtain by pulverizing the sorbent particles prior to injection into the furnace. The closer in time that such pulverization occurs relative to the injection, the better the effect, since there is less time for subsequent agglomeration to occur. Furthermore, the presence of warm or hot process air from the near-by boiler can be used to reduce the relative humidity of the environment, and thereby reduce the moisture in the sorbent.

### Control of Sorbent Injection

Sorbent 600 costs are an important part of the cost of the process. It should be noted that the precise amount of sorbent 600 required for desulfurization will be different depending on the amount of sulfur in the coal, the amount of water in the coal, on the quality of the sorbent 600 (which can vary depending on the batch of lime, the specific conditions of the hydration and reaction with clay, among other factors), on the heat in the furnace, and possibly even on environmental conditions (e.g. the humidity of the intake air, either during sorbent production or during furnace operation).

In general, it should be noted, the amount sorbent 600 to sulfur is made in approximately 1.4 to 2.5 molar stoichiometric ratio of lime 100 to sulfur. However, the amount of sorbent 600 required depends somewhat on the amount of sulfur in the coal—with lower amounts of sulfur, the amount of lime 100 that is unreacted (and therefore maintains reactivity) is high, but a certain concentration of lime 100 in the flue gas must be maintained to maintain the rate of reaction with sulfur oxides.

It should also be noted that in many cases, there is no absolute optimum degree of desulfurization—e.g. that 99% is not “better” than 95% reduction in sulfur, if the costs associated with sulfur removal are non-economic (and might be better used in reducing sulfur pollution at a different site with more effective sulfur reduction potential). In most cases, the optimum amount of desulfurization is dependent on the cost of sulfur pollution credits relative to the cost of the process (in this case, the operational costs, ignoring to the greater extent the capital costs). Therefore, if the cost of sulfur pollution credits is high, then it is economically beneficial to remove a higher fraction of the sulfur from the stream.

Embodiments of the present invention teach that the amount of sorbent added to the process be regulated in part by the cost of the pollution credits. Typically, this can operate in one of two ways. In one example, called “deterministic modeling”, a calibration of the system is roughly determined, in which the reduction in sulfur is determined for specific rates of sorbent use. This reduction can be computed either as a simple function of sorbent use, or can be determined as well for various internal and external factors (e.g. percent sulfur in the coal, ambient humidity, rates of coal utilization, etc.) From this information, the rate of sorbent utilization is determined such that the cost of an incremental increase in sorbent utilization is the same cost as the incremental cost of pollution credits due to the residual sulfur in the output waste stream. It should be noted that the cost of the pollution credits in this calculation can be the then current daily cost of sulfur pollution credits in public markets (e.g. sulfur dioxide credits on the Chicago Board of Trade), the average cost of credits that the operator of the plant has purchased and “stockpiled”, or other such value as reflects the cost of sulfur pollution.

In another example, called “empirical modeling”, similar calculations are made to those in the first method above, but the use of sorbent use and the measurement of sulfur in the stack outflow are made in roughly real time, so as not to depend on the deterministic response of desulfurization to sorbent use that can be multifactoral and hard to elucidate. In this case, real time measurements of sulfur (e.g. sulfur dioxide, or sulfur dioxide plus sulfur trioxide) in the output gas stream can be used to regulate in real time the sorbent utilization.

In empirical modeling, the amount of sulfur dioxide is determined roughly continuously. The cost of the pollution in sulfur dioxide credits is computed over the interval. Likewise, the amount of sorbent used is measured in real time, as well as other associated costs (e.g. the costs of disposal of the spent sorbent, the additional costs of associated with higher ESP burden, and other sorbent operating costs). If the cost of the pollutant credits is larger than that of operating expenses associate with the sorbent, the amount of sorbent is incrementally increased, and after a period of time to allow for equilibration of the system, a new cycle of measurements and adjustments in sorbent utilization is made. If the cost of the pollution credits is less than that of the sorbent-associated costs, then the sorbent utilization can be lowered.

It should be noted that in the case that the iron oxide is not an added component of the sorbent, but is added separately, it is useful to determine the additive response of the system to the two components. In this case, at any given time, the change in the sorbent and the change in the metal oxide utilization will be roughly according to the two dimensional gradient of desulfurization versus sorbent and metal oxide catalyst, with a cutoff at such point that the cost of the sulfur pollution credits is offset by the cost of the sorbent and iron oxide total. It should also be noted that being able to change the ratio of iron oxide to lime-clay sorbent for optimum desulfurization (that is, that the ratio of lime-clay sorbent to metal oxide catalyst need not be constant under all operational conditions) is another reason for having the metal oxide as a separate component to the sorbent.

### Use of Sorbent In Mercury Reduction

It has been reported that kaolin clays have mercury binding capabilities (e.g. Biermann, J P; Higgins, B; Wendt J O; Senior, C; Wang, D; “Mercury Reduction in a Coal Fired Power Plant at over 2000° F. using MinPlus Sorbent through Furnace Sorbent Injection” Paper presented at Electric Utilities Conference (EUEC),Tucson, Ariz., Jan. 23-25, 2006). The use of these materials for binding mercury generally takes place after the addition of clay into the boiler at locations in the boiler where the flue gas has a temperature of over 2000° F., resulting in a sorbent temperature of approximately 1800-1850° F.

The sorbents 600 of the present invention can also be used in binding mercury, provided that they are used at an elevated temperature, preferably exceeding flue gas temperatures of 1800° F. The temperature of use can be a compromise, in which a higher temperature can result in a higher mercury binding, but a lower sulfur binding, whereas a lower temperature can result in a higher sulfur binding, and lower mercury binding. It should be noted that such sorbents 600 must contain both a sulfur binding component (lime 100) and a mercury binding component (clay 200), which are bound together by the process of sorbent 600 production described above. To reiterate, the binding of the clay 200 and the lime 100 is secured either by added water 500 to mixtures of unhydrated lime 100 and clay 200, or by adding clay slurry 210 to unhydrated lime 100, which can be supplemented by water 500.

### Use of Polyanions For Mercury Removal

The removal of mercury from flue gas streams requires, in general, two different functions. In a first function, elemental mercury must be oxidized, usually to a Hg⁺² state (e.g. HgCl₂ or HgO). In a second function, the mercury oxide/salt is adsorbed onto a sorbent.

The lime and/or clay sorbents can be supplemented with materials that promote oxidation of the mercury. In a first method, iron oxide, which may be hematite or magnetite or other iron oxide form, is complexed with the sorbent as mentioned hereinabove. This iron oxide is generally in micro- or nano-particles with mean diameters preferably less than 10 microns, and more preferably less than 2 microns, and most preferably less than 1 micron. The particles are added during hydration of the lime that is part of the lime-based sorbents, and may be associated with the lime through the additional use of clay, which may be bentonite, montmorillonite, smectite or similar clay, which complexes with both the lime and the iron oxide particles in order to maintain close physical proximity, and prevents the iron oxide from settling out during shipment or handling. The iron oxide can serve as a catalyst for the oxidation of mercury.

Instead of iron oxides, certain iron salts can also be used to impregnate the sorbent, which are converted at high temperature in the presence of oxygen into iron oxides. Such salts can include iron halides salts such as ferric or ferrous chloride or iodide. The concentration of such salts is preferably between 0.1% and 5%, and more preferably between 0.5% and 2%.

It is known that the presence of halides improves the oxidation of mercury, and it is further a teaching of this invention to include halide salts during the hydration of clay, wherein the salt is preferably a sodium or potassium salt of chlorine, bromine or iodine. The salt is preferably dissolved in the water in which the lime sorbent is hydrated, and the concentration of salt is such that the percentage of salt is relative to calcium oxide between 0.05% and 5% and more preferably between 0.5% and 1%. It should be noted that this salt can interfere with crystal formation within the lime, and may reduce the amount of sintering that occurs in the lime crystal, thus improving its performance in SO_{X} absorption at high temperatures. However, the presence of sodium or potassium ions in the boiler has significant adverse affects, and in general, amounts of alkali earth compounds in excess of 1% is generally avoided.

It is also of use to directly add oxidizing agents to the lime during hydration, so as to thoroughly admix these agents into the lime sorbent. Examples of such agents include persulfates, such as ammonium persulfate or preferably sodium persulfate, permanganates such as sodium or potassium permanganate, or peroxides, such as hydrogen peroxide. Hydrogen peroxide, for example, can be added to the lime during hydration, forming calcium peroxide, and is preferably added as more than 0.5% of the total moles of water used in hydration, and more preferably as more than 2% of the hydration water, and most preferably as more than 10% of the water hydration. The only limitation to the amount of hydrogen peroxide is in economic terms, as more peroxide carries the benefit of additionally oxidixing SO₂ to SO₃, and thereby increasing its adsorption and stability in the lime. In the case of peroxide and permanganates, the amounts that are preferably included are between 0.05% and 5% by weight relative to the lime, and more preferably between 0.2% and 2% by weight relative to lime. As before, these solid salts are preferably dissolved in the water used to hydrate the lime. It should be noted that the presence of both halogen salts and oxidizing reagents together can have a synergistic effect.

The capture of oxidized mercury is opposed by a number of competing processes. In a first process, the mercurous or mercuric species, such as HgO, HgCl₂, HgSO₃, or HgSO₄ decompose at very high temperatures, such as those found in a boiler, into elemental mercury and O₂, Cl₂, SO₂, SO₃, and other species. In addition, many of the mercury species have appreciable vapor pressures at high temperature, so that they do not remain in the lime, clay, carbon or other sorbents. Once vaporized, they may not be recaptured by particles that are trapped by the electrostatic precipitator or baghouse, and given that small boilers rarely have scrubbers or other cold-side treatment, the mercury that escapes to the cold-side is lost to the environment.

In the preferred embodiment, a polyvalent, inorganic anion (polyanion) is added to the sorbent. This polyanion is preferably a polyphosphate, polymetaphosphate or other polyacids, for use at the highest temperatures of injection, but can include organic polyanions for injection at lower temperatures (e.g. less than 1800° F. with short residence times, or less than 1400° F. for longer residence times). Suitable polyanions include naturally occurring polyanions and synthetic polyanions. Examples of naturally occurring polyanions are alginate, carboxymethylamylose, carboxymethylcellulose, carboxymethyldextran, carageenan, cellulose sulfate, chrondroitin sulfate, chitosan sulfate, dextran sulfate, gum arabic, guar gum, gellan gum, heparin, hyaluronic acid, pectin, xanthan and proteins at an appropriate pH. Examples of synthetic polyanions are polyacrylates (salts of polyacrylic acid), anions of polyamino acids and copolymers thereof, polymaleinate, polymethacrylate, polystyrene sulfate, polystyrene sulfonate, phosphonomethylated polyethyleneimine (PPEI, polyvinyl phosphate, polyvinyl phosphonate, polyvinyl sulfate, polyacrylamide methylpropane sulfonate, polylactate, poly(butadiene/maleinate), poly (ethylene/maleinate), poly (ethacrylate/acrylate) and poly (glyceryl methacrylate).

It should be noted that it is preferable to have a polyanion that has a preference for Hg cations over that of Ca⁺², so that that very large amount of ambient calcium does not overwhelmingly interfere with the binding of mercury cations to the polyanion. Polyphosphate, for example, does indeed show such a preference, as do many polyanions.

The amount of polyanion is preferably more than 0.1% and less than 10% of the lime concentration, and more preferably more than 0.3% and less than 5%, and most preferably more than 0.5% and less than 2% of the mass of lime in the sorbent. Furthermore, it is preferable for the polyanion to be dissolved in the water used for hydration of the lime, although this is not a requirement for its use.

It should be noted that the combination of the polyanion with lime is not essential. For example, in a second preferred embodiment, polyanion is added to micro- or nano-particles of iron oxide, wherein the iron oxide serves to catalyze the oxidation of mercury, and the polyanion thereafter immobilizes the oxidized mercury to the particle. The particles are prepared by the mixing the iron oxide particles with polyanion solutions, which are subsequently dried so that the polyanion dries to the surface of the iron oxide, to which it sticks by virtue of the attraction of the iron cations in the particle to the anions in the polyanion.

Alternatively, polyanions can be used with other high surface area sorbents, such as activated carbon, vermiculite, zeolites, or other clays, wherein the polyanion binds to these surfaces, and provides additional high binding capacity to these sorbents. Such sorbents can be prepared by adding solution with dissolved polyanions to these sorbent foundations (e.g. activated carbon, vermiculite, etc.) and then drying the resulting product, leaving the polyanions admixed with the foundation.

It should be noted that the use of sorbents using these polyanions bound to solid substrates is not limited to the hot-side of the boiler, but may also be used in cold-side mercury removal.

Because the polyanions generally decompose at higher temperatures such as are founding a boiler near the burners or before the superheaters, for example, and higher efficiency of SO_{X} removal is generally found with higher temperature injection, it can be advantageous to inject a sorbent optimized for SO_{X} removal at a higher temperature location, and to inject a sorbent for mercury removal at a lower temperature location.

### Use On the Cold Side For Mercury Reductions

There are generally distinguished two types of flue gas desulfurization categories, being “hot-side” and “cold-side”. The “hot-side” is generally located between the boiler economizer and the air heater, while the “cold-side” is after the boiler air heater and smokestack particulate removal devices. The temperature of the gas in the cold-side is typically 300° F. or lower.

It should also be noted that when used on the “cold-side”, all three species of the sorbent 600 (lime 100, the iron oxide 300 and the clay 200) have elemental mercury or mercuric oxide binding capacities (e.g. Livengood, C.D.; Huang, H. S.; Mendelsohn, M. H.; Wu, J. M. “Enhancement of Mercury Control in Flue Gas Cleanup Systems”. Presented at the First Joint Power & Fuel Systems Contractors Conference, Pittsburgh, Pa., July 1996; Evan J. Granite, Henry W. Pennline, and Richard A. Hargis. “Novel Sorbents For Mercury Removal From Flue Gas”, Industrial & Engineering Chemistry Research, vol. 39, pp. 1020-1029, April 2000; and National Risk Management Research Laboratory (2002), “Control Of Mercury Emissions From Coal-Fired Electric Utility Boilers: Interim Report Including Errata Dated Mar. 21, 2002”, Prepared for Office of Air Quality Planning and Standards). The iron oxide 300 capacity is small, but the amounts of iron oxide in the sorbent 600 are large enough to provide significant overall capacity. Furthermore, iron oxide 300 can serve as a catalyst for the oxidation of elemental mercury to oxidized mercury at cold-side temperatures (see, e.g.). It should also be noted that the capture of mercury by lime 100 is somewhat dependent on the surface area of the lime 100, such that the protection of the lime 100 afforded by the clay 200 preserves then some part of the binding capacity of the lime 100 for mercury. Furthermore, any exfoliated clay that is release from binding with the lime in the extreme temperatures of the boiler has a large surface area to bind with the mercury.

It is thus convenient to take a fraction of the spent sorbent 600 from the hot-side ESP and to inject it into the cold-side (or to allow some sorbent 600 to pass through from the hot-side into the cold side), in order to reduce mercury. The capture of sulfur oxides by the lime 100 appears not to have a deleterious effect on the binding of mercury, and may indeed improve the sorbent 600 performance in this regard. Certainly, the presence of lime 100 that has not reacted with sulfur should lower the amount of sulfur trioxide present, which acts to reduce the oxidation of mercury.

Furthermore, it should be noted that by maintaining even partially used sorbent 600 in the cold-side will lead to continued reductions in sulfur oxides through reaction with unreacted lime 100.

### Use On the Hot Side In Conjunction With Alternative Cold Side Desulfurization

It should be noted that the use of the sorbent 600 on the hot side does not generally result in the complete removal of sulfur oxides. In addition, cold side desulfurization also generally does not result in the complete removal of sulfur. Furthermore, to get very high sulfur removal (e.g. 99% or more), cold side desulfurization (e.g. scrubber technology) must operate at very high efficiencies that are hard to maintain on an operational basis. An alternative method of utilization of the sorbent 600 of the present invention is to use the sorbent 600 on the hot side, with further removal of sulfur on the cold side, for example, using conventional scrubber technology. If the sorbent 600 removes X % of the sulfur dioxide, and the scrubber removes of the remainder Y % of the sulfur dioxide, the total removal is then 1−(1−X)(1−Y) %. Thus, if the goal is to remove 99% of the sulfur dioxide, and the sorbent removes 70% of the sulfur, the scrubber technology must then remove only 96.67%, rather than the more difficult to achieve 99%. Likewise, if the sorbent 600 removes 80% of the sulfur, the scrubber technology must then remove only 95%. In general, removing the last few percentages of sulfur oxides is more expensive than removing the first percentages, so that this can in certain cases be a cost effective method of achieving a level of sulfur oxide reduction mandated by regulatory authorities.

It should also be noted that spent sorbent from hot side operation has significant sulfur oxide reactivity, as the sorbent 600 is generally used at a molar stoichiometry of 1.4-2.0 relative to that of the sulfur oxides, so that 50% or more of the lime 100 remains unreacted even at high sulfur oxide removal. Thus, the “spent” sorbent 600 still has capacity to react with sulfur oxides, and can be used as additional capacity in cold-side scrubbers. In the prior reference, this is rarely done, as the unreacted lime 100 generally has little or no reactivity for sulfur oxides, having been agglomerated and sintered, thus reducing the capacity of the unreacted lime 100, in contrast to that of the present invention.

### Use of Lime Microparticles And Nanoparticles

The foregoing discussion has dealt primarily with the use of conventional lime fines in the production of the sorbent. In this section, methods are described that provide for the production of smaller sorbent particles. The purpose of the smaller lime particles is two-fold. In the first case, smaller particles have intrinsic bulk surface area, which is distinguished from that of internal surface area created by cracks or pores. Such bulk surface area has the advantage of being durable, inasmuch as it persists longer than that of cracks or pores, which eventually plug as SO_{X} is reacted.

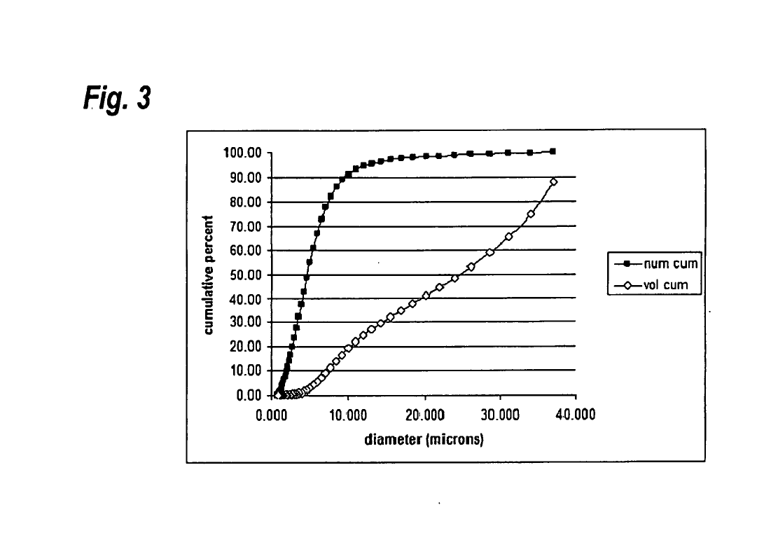

A second advantage of smaller particles is that there are a larger number of particles for a given weight. This leads to more particles per volume in the boiler. In standard sorbents, it should be noted, the density of particles can be in the single digits to thousands per cm² on average. FIG. 3 is a graph of the cumulative distribution of particles either by number (filled in squares) or by mass (open diamonds) for a sorbent preparation with a nominal diameter of 5 microns. The median particle diameter (by number of particles) is about 5 microns in diameter, whereas the median particle by mass is at about 25 microns in diameter. Since these median particles by mass have 5 times the diameter of those by number, these larger particles are present in numbers approximately 125 times less than those of the smaller particles (i.e. the cube of the difference), supporting a far lower reaction rate. Clearly, decreasing the mean particle diameter has a high value.

### Microparticles From Droplets of Soluble Sorbents

In the following discussion, the alkali or alkaline base used in the sorbent process will generically be called the sorbent base. In one embodiment, solutions of soluble sorbent bases are made in water, and very small droplets are produced from the solutions. The water in the droplets is evaporated, leaving small particles of sorbent. To make this a commercial process, very small droplets need to be made, since the size of the droplets determines the size of the particles, and the size of the particles determines the number of particles.

The sorbent base should be soluble, and this can be in either an aqueous medium or an organic solvent. A good example of such a system is sodium sesquicarbonate (also known as trona) in water, and can also be soda ash, potash, or other soluble sorbent compounds. These will generally be carbonate or bicarbonate compounds of metals or alkaline earth metals. For example, while calcium carbonate has only limited solubility in water (a fraction of a gram per liter), calcium bicarbonate (or calcium hydrogen carbonate), formed by the reaction of calcium carbonate with carbonic acid, is 100× or more soluble in water (e.g. 16 grams of calcium bicarbonate is soluble in 100 grams of water at 20° C.).

It is an advantage to form the smallest water droplets as possible—if one attempts to make smaller solid particles from the droplets, the smaller the droplet, the less water that needs to be evaporated from the droplets. If the solids comprise 1% of the solution, for example, to make 1 ton of sorbent would require evaporating 100 tons of water. In general, it is preferable for the solution to be at least 5% sorbent base (e.g. sodium sesquicarbonate), and more preferable for the solution to be at least 10% sorbent base, and most preferable for the solution to be at least 20% sorbent base.

It should also be noted that the more concentrated the solution, the smaller the droplets need to be. Furthermore, the amount of energy needed to make a droplet increases strongly with decreasing size, and many common “fog” methods make droplets on the size of tens of microns, whereas the present invention has preference for droplets 1-5 microns or less in size.

To make smaller droplets, a preferred method employs the use of jets of water that impinge on solid surfaces or on other opposing water jets, wherein the velocity of the water jet is in excess of 200 m/sec. Such water jet technology is well known in the art of water jet cutters, which can deliver water jets with velocities in excess of 400 m/sec.

In such a methodology, one water jet is aimed at a solid surface, which may be rotating or moving at a high speed, or alternatively, two water jets can be aimed at one another such that the angle of incidence is small (in this sense, the angle of incidence is 0° if the jets are aimed directly at one another)—it is preferably less than 30°, and more preferably less than 20°, and most preferably less than 10°. Thus, if the two jets both have velocities of 250 m/sec, and the angle of incidence is 0°, then the relative velocity at the point of impact is 500 m/sec. At 400 m/sec for each individual water jet, the relative velocity is 800 m/sec.

If only one water jet is employed, an extremely hardened target is used, which can be beryllium-strengthened alloys, polyynes, or minerals such as diamond or quartz.

At the point of impact between the water jets, significant air turbulence will be encountered (i.e. while some of the kinetic energy is used to make up for the surface tension of the fluid, the rest is imparted to the individual droplet velocities). The kinetic energy imparted to the air and the droplets can be used to help in dispersal of the sorbent.

As the surface tension increases (e.g. through the presence of the sorbent salt), the size of droplets created increases, other things being the same. In order to decrease the surface tension, there are two alternatives. In a first alternative, surfactants are added to the solution. A convenient surfactant is Softanol-90, which is active in very small concentrations (preferably more than 0.001%, and more preferably more than 0.005%, and most preferably more than 0.025%).

In addition, the surface tension of a fluid decreases as the temperature increases. In general, this effect is relatively modest—the surface tension of water, e.g. decreases by approximately 20% from 0° C. to 100° C. However, it should be noticed that the system in use here is at extremely high pressures, so that temperatures higher than the boiling point at atmospheric pressure can be utilized, resulting in lower surface tension.

### Microparticles From Precipitation Reactions

In another embodiment, microparticles of insoluble sorbents can be formed by the precipitation of multiple soluble species that react to form the insoluble sorbent. An example of this is calcium carbonate. In this case, reacting calcium chloride, a soluble salt of calcium, with sodium or potassium carbonate or bicarbonate, results in a precipitate of calcium carbonate. The size of the particles is determined in this case by the concentrations of the particles, the temperature of the solution, and such effects are well known in the prior reference.

Another example of this would be the reaction of sodium or potassium hydroxide with calcium chloride, precipitating out the relatively insoluble calcium hydroxide.

A further example is the precipitation of calcium carbonate from a solution of calcium bicarbonate (calcium hydrogen carbonate) which is either: (1) concentrated by removing the water through a combination of heat or lowered pressure, (2) heating to remove CO2 from solution, or (3) neutralizing the solution with sodium, potassium or calcium hydroxide.

Alternatively, the supernatant from a slurry of lime with concentrated calcium hydroxide can be reacted with carbon dioxide (e.g. bubbled through the solution), which forms a precipitate of insoluble calcium carbonate. This later means is commonly used in the preparation of precipitated calcium carbonate for the paper industry, and as a plastic additive.

During the precipitation, it is convenient to supplement the solution with iron oxide and/or clay. These additives can serve as nucleation sites for the precipitation, providing a tight connection between the additive and the sorbent base. Furthermore, in the final sorbent, the iron oxide and/or clay can be partially internal to the particle, providing a site for porosity through differential expansion, material mismatch, and the like.

### Microparticles From Vaporized Salts

Many of the sorbent bases boil at commercially available temperatures. Once vaporized, the material will condense as the temperature is dropped, at which point small particles are formed. This process is used to create small sorbent particles in another embodiment of the present invention.

Many of the conventional sorbent salts decompose prior to boiling, often to form alkali metal or alkaline earth metal oxides. For example, calcium carbonate decomposes at about 840° C. to form CaO and CO₂. What vaporizes then is not the sorbent salt, generally, but rather the equivalent oxide.

In the case of lime, at 840° C. the lime calcines, and at 2800° C., the CaO boils. It should be noted that the energy cost of vaporizing and then condensing the CaO is thermodynamically minimal (solid 4 gas 4 solid), and the energy that is used to vaporize the CaO can be recaptured during the cooling of the gas (e.g. using the vapor phase CaO to heat incoming solid CaO through a heat exchanger).

The size of the particles of CaO formed on condensation depends on the volume of air into which the CaO gas is contained, as well as the rate at which the temperature is reduced. Larger volumes of air and more rapid temperature quenching both contribute to smaller CaO particles.

Furthermore, in order to prevent the vapor from forming supersaturated concentrations of the CaO and to further regulate the size of the particles that are formed, seeds of either CaO or other solid materials can be added to the CaO containing gas. Such particles might include, for example, nanoparticles of iron oxide, which can be 5-100 nm in size. Even though these particles may not be optimal seeds since they are of differing chemical composition from the material being condensed, surface adsorption with two dimensional translation along the surface will form small collections of CaO molecules that will allow them to act as seeds.

The CaO quicklime that is collected can be used directly for furnace injection, rather than being hydrated, given that the particle sizes can be substantially less than 1-2 microns (in which case, porosity of the product is less important given the high surface area). Hydrating the CaO will further create porosity of benefit to the sorbent performance.

In practice, limestone or lime that is calcined in a conventional process is directly taken to the boiling point, so that the heat required for the calcining is not lost. Care is taken that the input CaO is put through heat exchangers as possible, to allow for heat from the CaO gas to be transferred to the incoming CaO. It is generally preferable for the incoming CaO to be fines or smaller pebbles, so as to improve the heat transfer. The gaseous CaO is provided enough air to maintain a concentration of vapor phase CaO, whose temperature drops as it passes through heat exchangers. As the CaO condenses, it is further cooled, and cool air can be mixed with the gas to reduce the growth of crystal size. When the temperature reaches a more modest level, the CaO particles can be collected by centrifugation, electrostatic precipitation, filtration (e.g. as through a bag house), etc.

### Microparticles From Microparticle Minerals

The vast majority of quicklime and lime hydrate is produced using limestone, since the highest commercial purposes for lime (e.g. in steel production) use larger stones—fines are often considered to be less useful. For sorbent use, however, the smaller the particles, roughly speaking, the better.

In this embodiment of the present invention, calcium carbonate minerals that are comprised of an agglomeration of microparticle CaCO₃ are used as the inputs to calcination, giving rise to a CaO product that is naturally comprised of microparticles. A common mineral having good properties in this regard is chalk, which can also be mixed with clays or iron silicates to form marls, and in the following discussion, all such minerals will be referred to as chalks. Chalk is formed from coccolithophores which leave behind calcium carbonate plates (coccoliths) that are from submicron sizes to 1-2 microns in size. It is important to test different chalks to establish the size distribution of the particles, as well as the aggregation properties of these particles, wherein smaller particles that are less tightly aggregated are preferable to those that are not. More specifically, chalks with particle sizes with a median particle diameter (measured by number) less than 5 microns are preferable, and more preferably less than 3 microns, and most preferably less than 2 microns. If a marl is used, it is preferable for the marl to have more than 50% calcium carbonate, and more preferable for it to have more than 67% calcium carbonate, and most preferable for it to have more than 75% calcium carbonate content.

It should be noted that the chalk can be prepared for use using different means.

In a first means, the material can be milled, pulverized, or otherwise treated so as to provide fine material. This can be used directly in furnace sorbent injection, preferably in combination with iron oxide and/or clay. That is, in the description above, the clay and iron oxide are combined in a calcium oxide hydration reaction, whereas in the present form, they are added simply as a clay hydration reaction. In this case, water is added to a combination of dry fine chalk, and one or both of iron oxide and clay, in amounts roughly similar to that given in the specification hereinabove, such that the final sorbent has an appropriate consistency and final moisture content (preferably less than 3%, more preferably less that 2% and most preferably less than 1%). In certain cases, it can be appropriate to allow an initial higher moisture content (e.g. 3-5%, which can then be reduced via heating to evaporate excess moisture.

Alternatively, mined chalk is calcined, either in a powder form, or alternatively in loose, pebble form, to form chalk lime. After calcining, if the material has not already been milled or pulverized, it can be done at this time if the chalk lime is to be used directly in furnace sorbent injection.

If the chalk lime is to be hydrated so as to increase its porosity, surface area, and other aspects that contribute to higher reactivity, water is added to the lime chalk in a manner typical of conventional hydrate, to form lime hydrate. This hydrate can then be used in furnace sorbent. Alternatively, the hydration can be performed as in the specification above in a manner similar to that performed for lime hydrates, combining the lime chalk with iron oxide and clay prior to or in conjunction with hydration.

### Application of Sorbent Microparticles

In our previous discussion, the many means of application of the microparticle sorbents have been disclosed, and their use on both the cold side and hot side of furnaces is taught in the present invention. In general, given the higher gas phase reactivity of sorbents at high temperature, the hot side use of these sorbents is of particular efficacy. It should be noted that in the previous discussion, the use of these microparticles in furnace sorbent injection is most commonly mentioned, but such microparticles can also be used in other methods, including in their use in fluidized bed reactors, in gaseous capture systems on the cold side of the furnace, and other sorbent based systems.

It should be noted that in the case of calcium-based and certain other sorbents, there are different chemistries that can be used. That is, one can use calcium carbonate, calcium oxide, and calcium hydroxide. In most of the cases contemplated with respect to microparticles, the use of the carbonate is well supported, as the increased porosity and surface area of the sorbent afforded by hydration, for example, is of less importance when the diameter of the particle is less than a couple of microns. In addition, the instantaneous calcination of the calcium carbonate that occurs in a furnace produces significant porosity on its own.

The preparation of the microparticles can occur either offsite from the furnace, or alternatively, onsite, where heat is highly available (for example, for the solubilization of salt solutions) and where significant amounts of carbon dioxide is available (e.g. for the production of calcium bicarbonate, which could be aided by bubbling flue gas through a solution to make carbonic acid).

### Terms

The “Terms” section provides a convenient condensation of terminology used in this specification, which should not be considered limiting and should be considered in combination with further explication elsewhere in this specification, or as used or understood by those skilled in the art.

Earth metals comprises both alkali and alkaline earth metals, including calcium, magnesium, sodium and potassium.

A sorbent base comprises an earth metal compound that, in a furnace, boiler, or other combustion location, will form an oxide base (e.g. CaO or Na₂O) in the form of either a carbonate (through calcinations), an oxide, or a hydroxide (through dehydration).

The sorbent base source is the physical form of the raw material from which the sorbent base is derived. For example, sorbent base sources include lime fines, chalk, precipitated calcium carbonate, ground calcium carbonate, or condensed calcium oxide.

Sorbent clays comprise broadly smectite, montmorillonite, bentonite, and other related clays, and which can comprise alkali earth metal or alkaline earth metal cation species.

Sorbent coating materials are materials that coat sorbent particles, and which can serve purposes such as providing thermal protection, providing surface area for non-specific adsorption, or preventing particle agglomeration.

Sorbent contaminant binding materials are materials which bind to contaminants, thereby capturing them and removing them from the flue gas stream as the binding materials (generally particles) are removed from the flue gas stream via electrostatic precipitators, baghouses or other means.

Sorbent oxidizing catalysts are generally solid state catalysts that promote the oxidation of flue gas contaminants, either directly to oxides (e.g. sulfur dioxide to sulfur trioxide, or elemental mercury to mercury oxides), or through increasing the oxidation number of a species, allowing it to become a salt (e.g. elemental mercury to mercurous or mercuric halides).

Transition metal oxides comprise iron oxides (which can comprise hematite, magnetite or other iron oxide species), chromium oxides, vanadium oxides, or other transition metal oxides.

Flue gas contaminants comprise sulfur oxides (e.g. sulfur dioxide and sulfur trioxide), nitrogen oxides (nitrogen monoxide or nitrogen dioxide), and mercury species, which comprise elemental mercury, and mercury oxides, and mercurous or mercuric salts.

Polyanions comprise a molecule with two or more anionic groups, which polyanion can comprise polyphosphate, polymetaphosphate or other polyacids, alginate, carboxymethylamylose, carboxymethylcellulose, carboxymethyldextran, carageenan, cellulose sulfate, chrondroitin sulfate, chitosan sulfate, dextran sulfate, gum arabic, guar gum, gellan gum, heparin, hyaluronic acid, pectin, xanthan, polyacrylates (salts of polyacrylic acid), anions of polyamino acids and copolymers thereof, polymaleinate, polymethacrylate, polystyrene sulfate, polystyrene sulfonate, phosphonomethylated polyethyleneimine (PPEI), polyvinyl phosphate, polyvinyl phosphonate, polyvinyl sulfate, polyacrylamide methylpropane sulfonate, polylactate, poly(butadiene/maleinate), poly (ethylene/maleinate), poly (ethacrylate/acrylate) and poly (glyceryl methacrylate).

Chalk comprises friable rock that have substantial calcium carbonate formed from coccolithophores, and which can also comprise clays so that the combination can be considered a marl. The percentage of calcium carbonate is considered to be more than 33%, and more preferably more than 67%.

Lime fines comprise quicklime which substantially passes through 100-400 mesh screens. Quicklime fines passing through 200 mesh are more preferable and quicklime fines passing through 325 mesh are most preferable.

Condensed calcium oxide comprises calcium oxide that has been heated above the boiling point, and cooled, so that calcium oxide condenses into small droplets.

Ground calcium carbonate is limestone which may have significant magnesium content (even over 50%), which is ground, milled, pulverized or otherwise size reduced into particles with a mean diameter in number of less than 20 microns, and preferably less than 10 microns.

Precipitated calcium carbonate is calcium carbonate which is formed from a solution of either calcium oxide or calcium bicarbonate, which then precipitates out calcium carbonate through the addition of carbon dioxide, through heating to drive off water, by neutralization with a base, or by other means.

A sorbent foundation comprises a solid support for sorbent particles, onto which other sorbent compositions can be combined. For instance, a clay with large surface area can serve as a sorbent foundation for a mercury sorbent such a polyanion. The clay provides large surface area for the polyanion to react with oxidized mercury species.

Size reduction of materials involves pulverization, grinding, milling or other such mechanical action.

Pollution credits comprise the economic costs of releasing a particular pollutant or contaminant to the environment. For example, a sulfur dioxide credit comprises the cost of releasing one ton of sulfur dioxide into the environment, and since such credits are traded on economic exchanges, their cost can be estimated on an almost instantaneous basis.

### Many Embodiments Within the Spirit of the Present Invention

It should be apparent to one skilled in the art that the above-mentioned embodiments are merely illustrations of a few of the many possible specific embodiments of the present invention. It should also be appreciated that the methods of the present invention provide a nearly uncountable number of arrangements.

Numerous and varied other arrangements can be readily devised by those skilled in the art without departing from the spirit and scope of the invention. Moreover, all statements herein reciting principles, aspects and embodiments of the present invention, as well as specific examples thereof, are intended to encompass both structural and functional equivalents thereof. Additionally, it is intended that such equivalents include both currently known equivalents as well as equivalents developed in the future, i.e. any elements developed that perform the same function, regardless of structure.

In the specification hereof any element expressed as a means for performing a specified function is intended to encompass any way of performing that function. The invention as defined by such specification resides in the fact that the functionalities provided by the various recited means are combined and brought together in the manner which the specification calls for. Applicant thus regards any means which can provide those functionalities as equivalent as those shown herein.

What is claimed is:

1. A sorbent for the furnace sorbent injection capture of flue gas contaminants comprising: a sorbent base with dry mix fraction between 64% and 95%; a sorbent clay with dry mix fraction between 4% and 30%; transition metal oxide with dry mix fraction 1% and 6%; and wherein the sorbent has added water such that the excess moisture is less than a predetermined amount.

2. The sorbent of claim 1 additionally comprising a polyanion in a weight fraction between 0.05% and 5%.

3. (canceled)

4. The sorbent of claim 1, wherein the sorbent base comprises calcium oxide or sodium sesquicarbonate, and wherein the sorbent base source is selected from the group consisting of chalk, condensed calcium oxide, pulverized calcium carbonate, and precipitated calcium carbonate.

5.-7. (canceled)

8. The sorbent of claim 1, wherein the sorbent clay comprises a smectite.

9. The sorbent of claim 1, wherein the transition metal oxide comprises an iron oxide.

10.-14. (canceled)

15. A method for the preparation of a sorbent for furnace sorbent injection capture of flue gas contaminants comprising: combining in dry form a sorbent base with dry mix fraction between 64% and 95%, a sorbent clay with dry mix fraction between 4% and 30%, and a transition metal oxide with dry mix fraction 1% and 6%; mixing water into the dry form combination in amounts of water so as to yield a final excess moisture of less than 2%; and ‘blending the dry form combination and the mix water until the sorbent is a free-flowing powder.

16. The method of claim 15, further comprising incorporating into the sorbent a polyanion in a weight fraction between 0.05 and 5%.

17.-32. (canceled)

33. The method of claim 15, further comprising a second mixing with water, wherein the second mixing occurs during the step of blending.

34. (canceled)

35. The method of claim 15, further comprising pulverizing the sorbent after the blending to reduce the size of the sorbent particles.

36.-37. (canceled)

38. A method for the injection of sorbent into a furnace for the capture of flue gas contaminants, comprising: storing the sorbent in a storage bin; transporting the sorbent from the storage bin to an eductor on the side of the furnace, wherein the eductor is located at a location with a predetermined furnace temperature; injecting the sorbent under gas pressure into the flue gas; and collecting the sorbent from the flue gas; wherein the sorbent comprises a sorbent base with dry mix fraction between 64% and 95%, a sorbent clay with dry mix fraction between 4% and 30%, and a transition metal oxide with dry mix fraction I % and 6%.

39.-42. (canceled)

43. The method of claim 38, wherein the predetermined temperature is greater than 1800° F.

44.-45. (canceled)

46. A sorbent for the furnace sorbent injection capture of flue gas contaminants comprising: a sorbent foundation; and a polyanion which is admixed with the sorbent foundation.

47. (canceled)

48. The sorbent of claim 46 additionally comprising a halide salt wherein the halide is selected from the group consisting of chloride, bromide and iodide.

49.-53. (canceled)

54. The sorbent of claim 46, further comprising an oxidizing catalyst.

55. (canceled)

56. A sorbent for the furnace sorbent injection capture of flue gas contaminants comprising: a contaminant binding material; an oxidizing catalyst; and a coating material; wherein the sorbent comprises free-flowing particles with less than a predetermined diameter.

57.-62. (canceled)
